(19) United States
(12) Patent Application Publication
(10) Pub. No.: US 2012/0216667 A1
(43) Pub. Date: Aug. 30, 2012

(54) MUSICAL PERFORMANCE APPARATUS AND ELECTRONIC INSTRUMENT UNIT

(75) Inventor: Naoyuki Sakazaki, Tokyo (JP)

(73) Assignee: CASIO COMPUTER CO., LTD., Tokyo (JP)

(21) Appl. No.: 13/404,597

(22) Filed: Feb. 24, 2012

(30) Foreign Application Priority Data
Feb. 28, 2011 (JP) 2011-041139

(51) Int. Cl. G10H 3/14; G10H 3/00

(52) U.S. Cl. 84/725; 84/723

(57) ABSTRACT

A sound generation timing is set as when a position of a playing device main body (11) is positioned within a main region as well as the position thereof being positioned in a sub region, and a CPU (21) generates a Note-On-Event with a tone stored in a main region/tone table and associated with the main region, and with a pitch stored in a sub region/pitch table and associated with the sub region. The Note-On-Event is transmitted from the playing device main body (11) to a electronic instrument unit (10), and a sound source unit (31) of the electronic instrument unit generates and outputs a musical sound of a tone and pitch in accordance with the Note-On-Event.

This application is based upon and claims the benefit of priority from the prior Japanese Patent Application No. 2011-41139, filed Feb. 28, 2011, and the entire contents of which are incorporated herein by reference.

### BACKGROUND OF THE INVENTION

1. Field of the Invention

The present invention relates to a musical performance apparatus and an electronic instrument unit that are held and swung by a performer's hand to generate a musical sound.

2. Related Art

Conventionally, electronic musical instruments have been proposed in which a sensor is provided in a stick-shaped member. These electronic musical instruments are configured such that, by a performer holding and swinging the stick-shaped member, the sensor detects the movement of the member and generates a musical sound. Specifically, such electronic musical instruments are provided with a stick-shaped member such as a stick for drums and are configured such that a percussion sound is generated in response to a performer's movement as if the performer were actually beating a drum or a Japanese drum.

For example, Japanese Patent No. 2663503 proposes a musical performance apparatus including a stick-shaped member provided with a sensor, in which a musical sound is generated when a predetermined period of time lapses after an output (an acceleration sensor value) from the acceleration sensor reaches a predetermined threshold.

The musical performance apparatus disclosed in Japanese Patent No. 2663503 has a disadvantage in that the generation of the musical sound is solely controlled based on the acceleration sensor value of the stick-shaped member, and thus it is difficult to realize variation in musical sound that is desired by a performer.

Furthermore, Japanese Unexamined Patent Application, Publication No. 2007-256736 proposes an apparatus that can generate a plurality of tones using a geomagnetic sensor. This apparatus is configured such that the geomagnetic sensor detects the orientation of a stick-shaped member being directed to so as to generate any tone from among the plurality of tones. The apparatus disclosed in Japanese Unexamined Patent Application, Publication No. 2007-256736 has a disadvantage in that, since a tone is altered based on the orientation of the member, when the number of types of tones to be generated increases, the angle range assigned to each of the tones becomes narrower, a result of which it becomes difficult to generate a musical sound of the desirable tone.

It is an object of the present invention to provide a musical performance apparatus and an electronic musical instrument that can desirably change a musical note component including the tone and pitch in accordance with a performer's intention.

### SUMMARY OF THE INVENTION

The object of the present invention is achieved by a musical performance apparatus comprising: a held member that a performer can hold by hand; a tone storing unit that stores information which specifies a main region having at least a lateral surface in a space demarcated by a surface that is perpendicular to ground level, and a tone of a musical sound that is associated with the main region; a pitch storing unit that stores information which specifies a sub region that is positioned in the main region, and a pitch of a musical sound that is associated with the sub region; a positional information acquisition unit that acquires information of a position of the held member; a reading unit that reads, from the tone storing unit, a tone associated with the main region in which a position of the held member resides when the position of the held member acquired by the positional information acquisition unit is within the main region and resides within the sub region, and that reads, from the pitch storing unit, a pitch associated with the sub region to which the position of the held member resides; and a sound generation instructing unit that instructs a sound generating unit to generate a musical sound having the tone and pitch read by the reading unit.

### BRIEF DESCRIPTION OF THE DRAWINGS

FIG. 1 is a block diagram showing a configuration of an electronic musical instrument according to a first embodiment of the present invention;

FIG. 2 is a block diagram showing a configuration of a playing device main body according to the present embodiment;

FIG. 3 is a flowchart showing an example of processes executed in the playing device main body according to the present embodiment;

FIG. 4 is a flowchart showing an example of an existing position acquisition process according to the present embodiment;

FIG. 5 is a flowchart showing an example of a main region setting process according to the present embodiment;

FIG. 6 is a flowchart showing an example of a tone setting process according to the present embodiment;

FIG. 7 is a diagram schematically showing the determination of a main region according to the present embodiment;

FIG. 8 is a diagram showing an example of the main region/tone table in RAM according to the present embodiment;

FIG. 9 is a flowchart showing an example of a sub region setting process according to the present embodiment;

FIG. 10 is a flowchart showing an example of a pitch setting process according to the present embodiment;

FIG. 11 is a diagram schematically showing the determination of a sub region according to the present embodiment;

FIG. 12 is a diagram showing an example of a sub region/pitch table in RAM according to the present embodiment;

FIG. 13 is a flowchart showing an example of a sound generation timing detecting process according to the present embodiment;

FIG. 14 is a flowchart showing an example of a Note-On-Event generation process according to the present embodiment;

FIG. 15 is a diagram schematically showing an example of a sub region and a corresponding pitch that are set in the sub region setting process and the pitch setting process of the playing device main body according to the present embodiment;

FIG. 16 is a flowchart showing an example of processes executed in the instrument unit according to the present embodiment;

FIG. 17 is a diagram showing an example of a sub region setting process according to a second embodiment;

FIG. 18 is a diagram schematically showing an example of a sub region and a corresponding pitch that are set in a sub region setting process and a pitch setting process of the playing device main body according to the present embodiment;

FIG. 19 is a flowchart showing an example of a main region setting process according to a third embodiment;

FIG. 20 is a flowchart showing an example of a sub region/pitch setting process according to a fourth embodiment;

FIG. 21 is a diagram schematically showing a sub region set in the sub region/pitch setting process of the playing device main body according to the present embodiment;

FIG. 22 is a flowchart showing an example of a second tone setting process according to a fifth embodiment;

FIG. 23 is an example schematically showing a main region and a sub region of combined embodiments;

FIG. 24 is a flowchart showing an example of a main region setting process according to an alternative embodiment;

FIG. 25 is a flowchart showing a sub region setting process according to the alternative embodiments;

FIG. 26 is a diagram showing an example of a main region and a sub region according to the alternative embodiments;

FIG. 27 is a flowchart of a sound generation timing detecting process according to other configurations;

FIG. 28 is a flowchart of a sub region according to other configurations;

FIG. 29 is a flowchart of Note-On-Event according to the present configuration; and

FIG. 30 shows a modified example of the shape of the sub region according to the fourth embodiment.

### DETAILED DESCRIPTION OF THE INVENTION

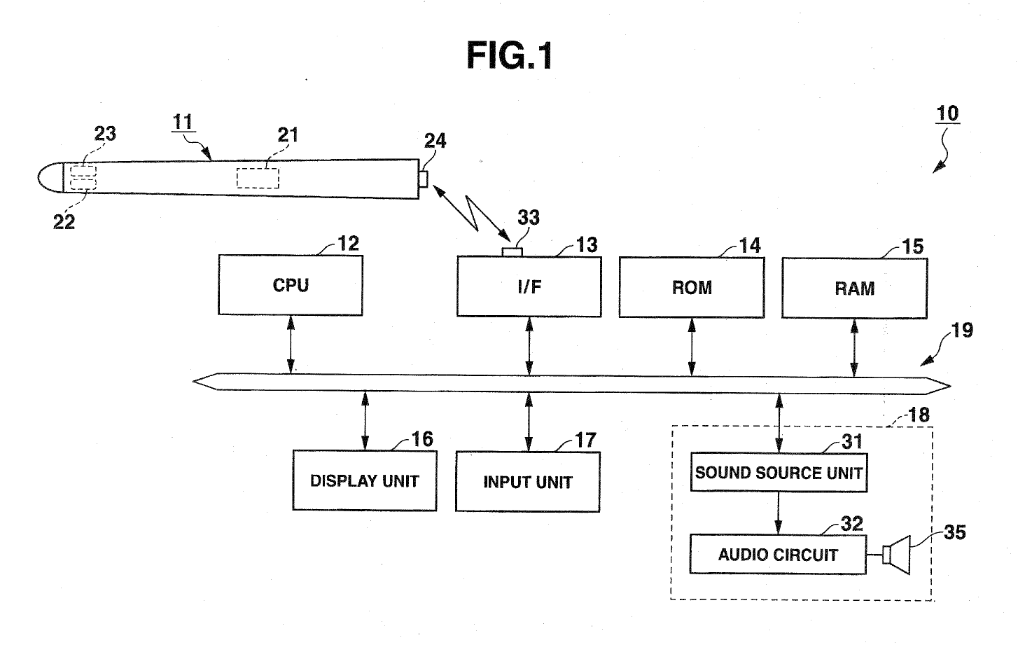

In the following, embodiments of the present invention will be explained with reference to the drawings. FIG. 1 is a block diagram showing a configuration of an electronic musical instrument according to a first embodiment of the present invention. As shown in FIG. 1, an electronic musical instrument 10 according to the embodiment includes a playing device main body 11 of a stick shape extending in a longitudinal direction as a held member for a performer to hold by hand and swing. In addition, the electronic musical instrument 10 includes an instrument unit 19 for generating musical sound, the instrument unit 19 including a CPU 12, an interface (I/F) 13, ROM 14, RAM 15, a display unit 16, an input unit 17, and a sound system 18. The playing device main body 11 includes an acceleration sensor 23 and a geomagnetic sensor 22 in the vicinity of a tip end side, which is an opposite side to a base side that is held by the performer, as described later.

The I/F 13 of the instrument unit 19 receives data (for example, Note-On-Event) from the playing device main body 11, stores the received data in the RAM 15, and notifies the CPU 12 of data reception. In the present embodiment, for example, an infrared communication apparatus 24 is provided at an end on the base side of the playing device main body 11, and an infrared communication apparatus 33 is also provided to the I/F 13. Therefore, the instrument unit 19 can receive data from the playing device main body 11 by the infrared communication apparatus 33 of the I/F 13 receiving infrared light emitted from the infrared communication apparatus 24 of the playing device main body 11.

The CPU 12 executes various processes for the control of the electronic music instrument 10 overall, particularly for the control of the instrument unit 19 of the electronic musical instrument, the detection of operations via key switches (not illustrated) that configure the input unit 17, and the generation of musical sound based on Note-On-Event received via the I/F 13, for example.

The ROM 14 stores various process programs for the control of the electronic music instrument overall, particularly for the control of the instrument unit 19 of the electronic musical instrument, the detection of operations via key switches (not illustrated) that configure the input unit 17, and the generation of musical sound based on Note-On-Event received via the I/F 13, for example. Furthermore, the ROM 14 includes a waveform data area that stores a variety of waveform data of tones, particularly waveform data of percussion such as a bass drum, hi-hat, snare, cymbal, and the like. The waveform data of tones is not limited to those of the waveform data of percussion, and the waveform data of tones from horns such as a flute, saxophone, trumpet, and the like, clavier such as a piano, strings such as a guitar, as well as other percussion such as a marimba, vibraphone, tympani, and the like may be stored in the ROM 22.

The RAM 15 stores a program read from the ROM 14 and data or parameters generated during process flow. The data generated during process flow include, for example, an operating state of a switch of the input unit 17, a sensor value received via the I/F 13, a state of a produced sound of musical sound (a produced sound flag), and the like.

The display unit 16 includes a liquid crystal display apparatus (not illustrated) and can display the contents of a main region/tone table that associates tones selected and a main region (described later) with tones of musical sound, contents of a sub region/pitch table that associates a sub region with a pitch of musical sound, and the like, for example. Furthermore, the input unit 17 includes a switch (not illustrated) and allows for designation of a tone, for example.

The sound system 18 includes a sound source unit 31, an audio circuit 32, and a speaker 35. The sound source unit 31 reads waveform data from the waveform data area of the ROM 15 in accordance with the instruction from the CPU 12 to generate and output musical sound data. The audio circuit 32 converts the musical sound data outputted from the sound source unit 31 into an analog signal, amplifies the analog signal thus converted, and outputs it to the speaker 35. In this way, the musical sound is outputted from the speaker 35.

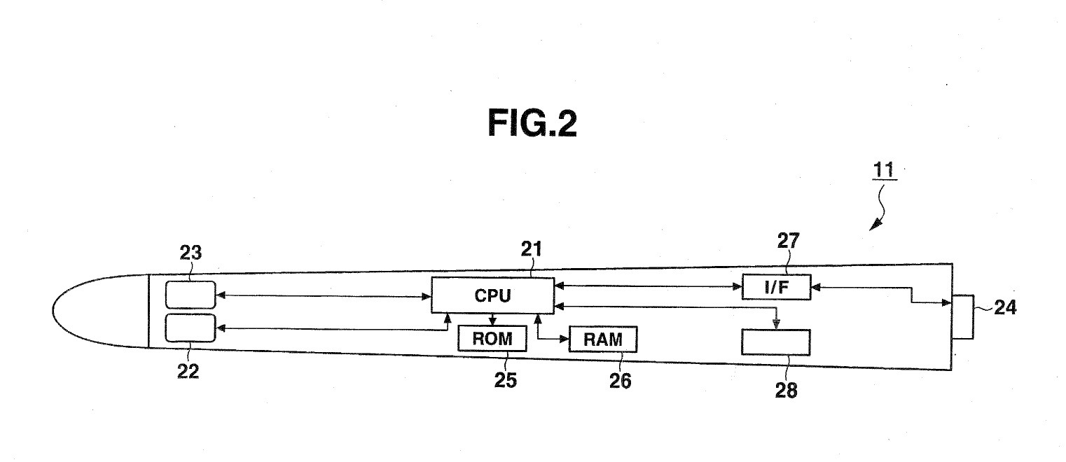

FIG. 2 is a block diagram showing a configuration of a playing device main body according to the present embodiment. As shown in FIG. 2, the playing device main body 11 includes a geomagnetic sensor 22 and an acceleration sensor 23 at a tip end side, which is an opposite side to a base side that is held by the performer. The location of the geometric sensor 22 is not limited to the tip end side, and it may be located at the base side. However, a performer often tends to swing the playing device main body 11 while regarding the location of the tip of the playing device main body 11 as a reference thereof (i.e., while viewing the tip by eye). Therefore, in consideration of acquiring positional information of the tip of the playing device main body 11, it is desirable to locate the geomagnetic sensor 22 at the tip end side thereof. It is particularly desirable to locate the acceleration sensor 22 at the tip end side of the playing device main body 11 so that variation in acceleration can be clearly expressed.

The geomagnetic sensor 22 is a triaxial magnetic sensor that includes a magnetoresistance effect element and Hall element and can detect each magnetic-field component in x, y, and z directions. Therefore, in the present embodiment, it is possible to obtain positional information (coordinate value) of the playing device main body 11 based on a sensor value of the triaxial magnetic sensor. Furthermore, the acceleration sensor 23, for example, is a capacitance type sensor or a piezoresistive element type sensor that can output a data value indicating an acceleration generated. The acceleration sensor 23 according to the present embodiment can obtain acceleration values (components) in the three axes directions of the long axis of the playing device main body 11, and the two axes perpendicular to the long axis, for example. A displacement of the playing device main body 11 can be calculated based on each of the components in the three axes directions obtained from the acceleration sensor. Furthermore, the sound production timing of a musical sound can be determined based on a component of the long axis direction of the playing device main body 11.

Furthermore, the playing device main body 11 includes a CPU 21, an infrared communication apparatus 24, ROM 25, RAM 26, an interface (I/F) 27, and an input unit 28. The CPU 21 executes processes such as acquiring a sensor value at the playing device main body 11, acquiring positional information in accordance with a sensor value of the geomagnetic sensor 22 and a sensor value of the acceleration sensor 23, setting a main region which is a region allowing for sound production of musical sound, setting a sub region which is a region defining a pitch of music to be produced in the main region, detecting the sound production timing of a musical note based on the sensor value (an acceleration sensor value) of the acceleration sensor 22, generating Note-On-Event, controlling transmission of the Note-On-Event via the I/F 27 and the infrared communication apparatus 24, and the like.

The ROM 25 stores process programs such as for acquiring a sensor value at the playing device main body 11, acquiring positional information in accordance with a sensor value of the geomagnetic sensor 22 and a sensor value of the acceleration sensor 23, setting a main region that is a region allowing for sound production of musical sound, setting a sub region that is a region defining the pitch of music to be produced in the main region, detecting sound production timing of a musical note based on the acceleration sensor value, generating Note-On-Event, and controlling transmission of the Note-On-Event via the I/F 27 and the infrared communication apparatus 24. The RAM 26 stores sensor values and the like, and values obtained or generated in the processes. The I/F 27 outputs data to the infrared communication apparatus 24 in accordance with an instruction from the CPU 21. Furthermore, the input unit 28 includes switches (not illustrated).

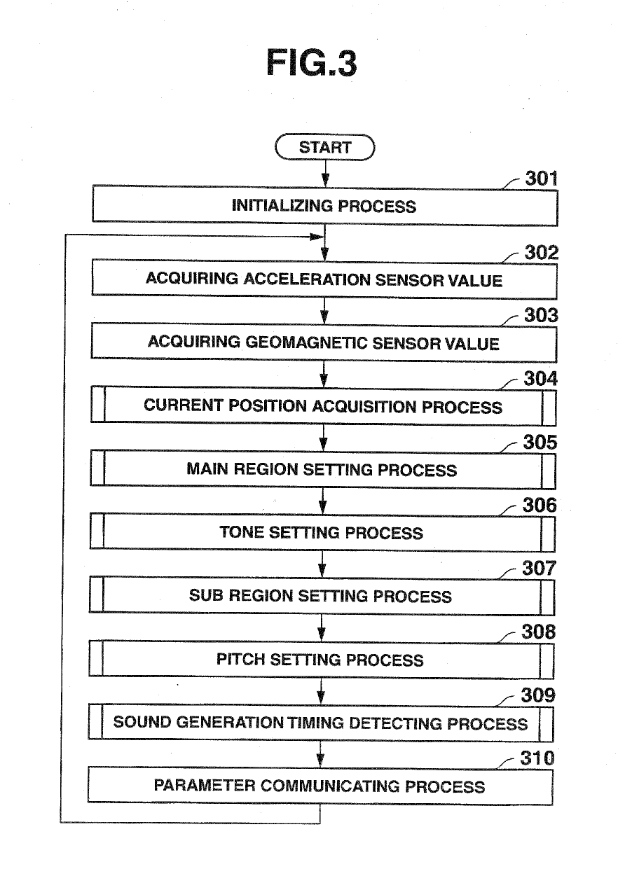

FIG. 3 is a flowchart showing an example of processes executed in the playing device main body according to the present embodiment. As shown in FIG. 3, the CPU 21 of the playing device main body 11 executes an initializing process including, for example, clearing data and flags in the RAM 26 (Step 301). A timer interrupt is cancelled in the initializing process. When the timer interrupt is cancelled, a sensor value of the geomagnetic sensor 22 and sensor values of the acceleration sensor 23 are read by the CPU 21 at a predetermined time interval in the playing device main body 11 and are respectively stored in the RAM 26. Furthermore, in the initializing process, the initial position of the playing device main body 11 is obtained based on an initial value of the geomagnetic sensor 22 and an initial value of the acceleration sensor 23, and are also stored in the RAM 26. The current position obtained in a current position acquisition process (Step 304) as described below is a relative position with respect to the initial position. Steps 302 to 310 are repeatedly executed after the initializing process.

The CPU 21 obtains a sensor value of the acceleration sensor 23 that is obtained from interrupt processing and stores it in the RAM 26 (Step 302). Furthermore, the CPU 21 obtains a sensor value (a geomagnetic sensor value) of the geomagnetic sensor 22 that is obtained from interrupt processing (Step 303).

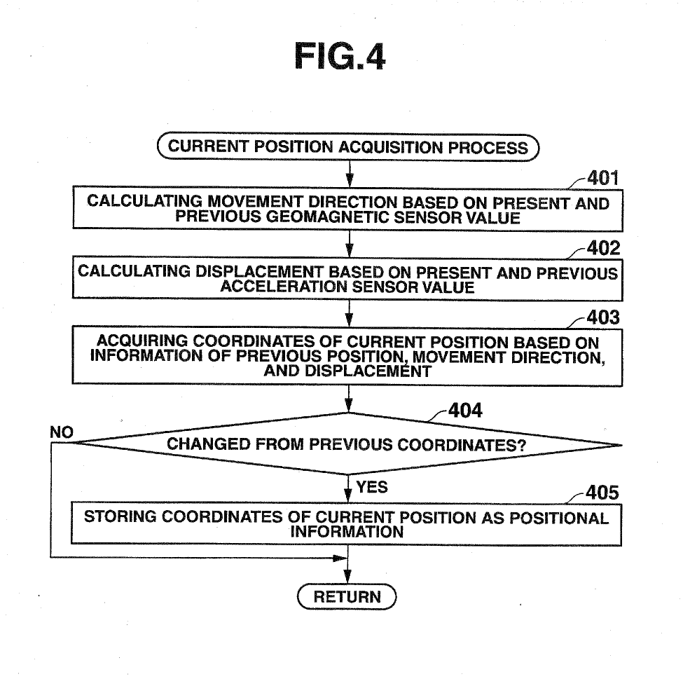

Then, the CPU 21 executes a current position acquisition process (Step 304). FIG. 4 is a flowchart showing an example of the current position acquisition process according to the present embodiment. As shown in FIG. 4, the CPU 21 calculates a movement direction of the playing device main body 11 based on the geomagnetic sensor value obtained in Step 303 previously executed, which was stored in the RAM 26, and a geomagnetic sensor value obtained in Step 303 presently executed (Step 401). As described above, since the geomagnetic sensor 22 according to the present embodiment is a triaxial geomagnetic sensor, it is possible to obtain the direction thereof based on a three-dimensional vector constituted by the differences in each component of the x component, y component, and z component.

Furthermore, the CPU 21 calculates the displacement of the playing device main body 11 based on the acceleration sensor value obtained in Step 302 previously executed, which was stored in the RAM 26, and the acceleration sensor value obtained in Step 302 presently executed (Step 402). This displacement can be obtained by integrating twice using the acceleration sensor values and the difference in acquisition time each acceleration sensor value (time interval). Then, the CPU 21 calculates a current position coordinate based on the previous positional information stored in the RAM 26 and the movement direction and displacement respectively obtained in Steps 401 and 402 (Step 403). The CPU 21 determines whether the coordinate thus calculated has changed from the previously position coordinate (Step 404). In the case of a “Yes” determination in Step 404, the CPU 21 stores the current position coordinate thus calculated as new positional information in the RAM 26 (Step 405).

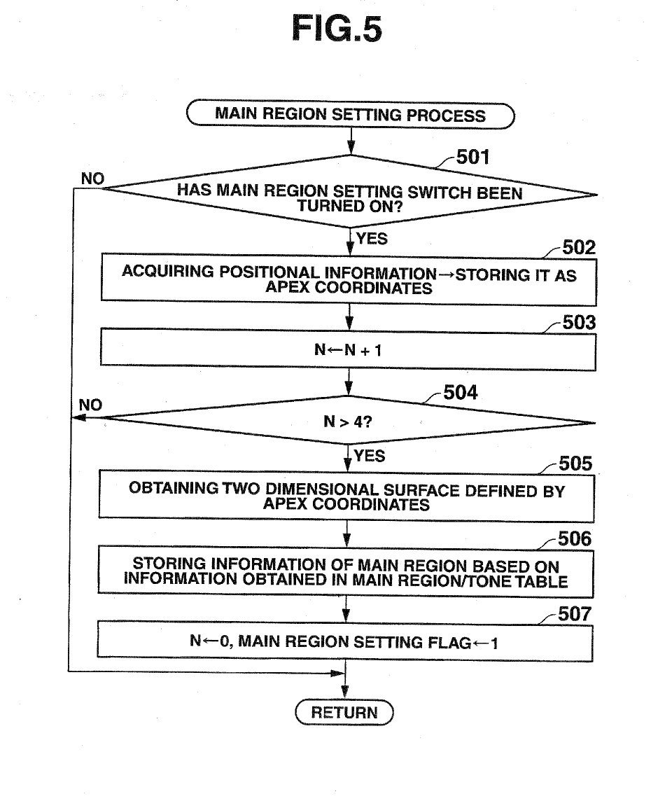

After the current position acquisition process (Step 304) in FIG. 3, the CPU 21 executes the main region setting process (Step 305). In the present embodiment, a performer uses the playing device main body 11 to designate the apexes of the region, and then a main region is configured by being demarcated by the plane on ground level onto which a two dimensional plane demarcated by the apexes is projected and by perpendicular lines extending from the apexes of the plane. Furthermore, in the present embodiment, a main region is demarcated in which the generation of musical sound by using the playing device main body 10 is allowed. Moreover, the actual musical sound is generated by setting a sub region that is associated with the pitch of the musical sound to be actually produced in the main region, as described later. In the following, a case of setting the main region using four apexes is explained. FIG. 5 is a flowchart showing an example of a main region setting process according to the present embodiment.

As shown in FIG. 5, the CPU 21 determines whether a main region setting switch in the input unit 18 has been turned on (Step 501). In the case of a “Yes” determination in Step 501, the CPU 21 obtains positional information stored in the RAM 26 and stores it as the coordinate of an apex (an apex coordinate) in the RAM 26 (Step 502). Then, the CPU 21 increments a parameter N indicating the number of apexes in the RAM 26. It should be noted that, in the present embodiment, the abovementioned parameter N is initialized to be “0” in the initializing process (Step 301 of FIG. 3). Then, the CPU 21 determines whether the parameter N is greater than “4” (Step 504). In the case of a “No” determination in Step 504, the main region setting process ends.

The case of a “Yes” determination in Step 504 means that the four apex coordinates are stored in the RAM 26. Therefore, in the case of a “Yes” determination in Step 504, the CPU 21 obtains information of a two dimensional plane (a quadrangle) that is defined by the four apex coordinates (Step 505). Then, the CPU 21 obtains the positions of the apexes of the quadrangle obtained by projecting the quadrangle on the ground level based on the information indicating the quadrangle thus obtained, and stores the information of the main region in a main region/tone table in the RAM 26 (Step 506). Then, the CPU 21 initializes the parameter N in the RAM 26 to “0” and sets the main region setting flag to “1” (Step 507).

In the present embodiment, the main region can be set based on the plane demarcated by apexes by a performer designating the apexes. In the abovementioned embodiment, the main region is set as a region of a plane (a quadrangle) of which the number of apexes is four. However, it is possible to set the main region of any polygon such as a triangle by changing the number of apexes.

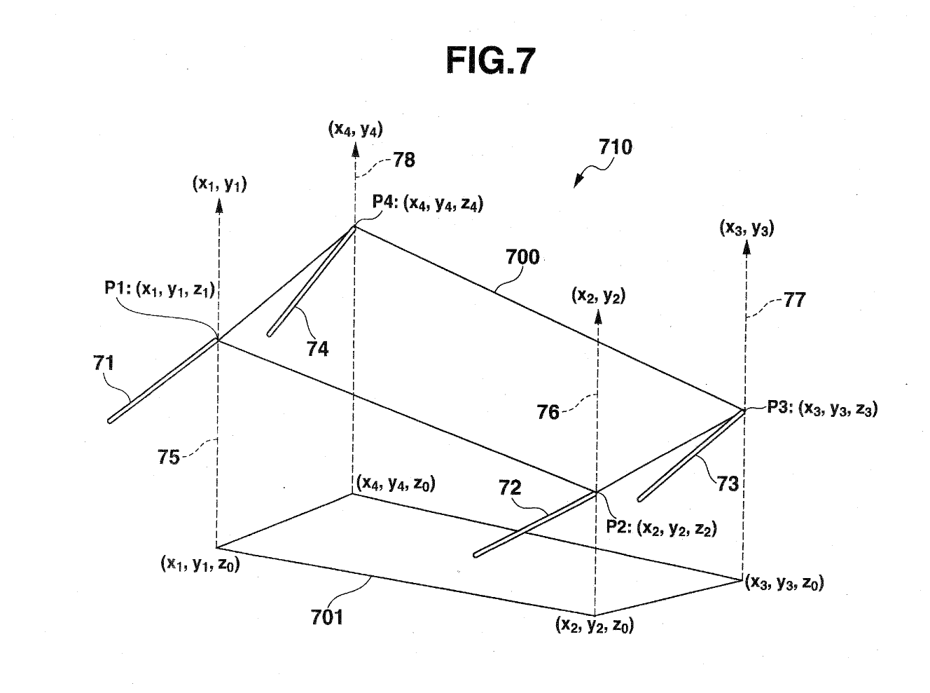

FIG. 7 is a diagram schematically showing the determination of the main region according to the present embodiment. The reference numerals 71 to 74 respectively show playing device main bodies when a performer turns on a main region setting switch. The positions of the tips of the playing device main bodies of the reference numerals 71 to 74 are each as follows:

P1 (reference numeral 71): (x₁, y₁, z₁);

P2 (reference numeral 72) : (x₂, y₂, z₂);

P3 (reference numeral 73): (x₃, y₃, z₃); and

P4 (reference numeral 74): (x₄, y₄, z₄).

Then, a surface obtained by these four coordinates being connected by straight lines is indicated by the reference numeral 700.

Furthermore, the coordinates of the apexes y on a surface 701 onto which the surface 700 is projected on the ground level (where z coordinate=z₀) are as follows:

(x₁, y₁, z₀);

(x₂, y₂, z₀);

(x₃, y₃, z₀); and

(x₄, y₄, z₀).

In the present embodiment, a space 710 is defined as the main region by the surface defined by the four coordinates (x₁, y₁, z₀), (x₂, y₂, z₀), (x₃, y₃, z₀) and (x₄, y₄, z₀) and perpendicular lines 75 to 78 extending from the four coordinates. As described later, when the playing device main body 11 is located within the space 710, it is possible to generate a musical sound by swinging the playing device main body 11. It should be noted that there may be other settings or shapes of the region, which will be described later.

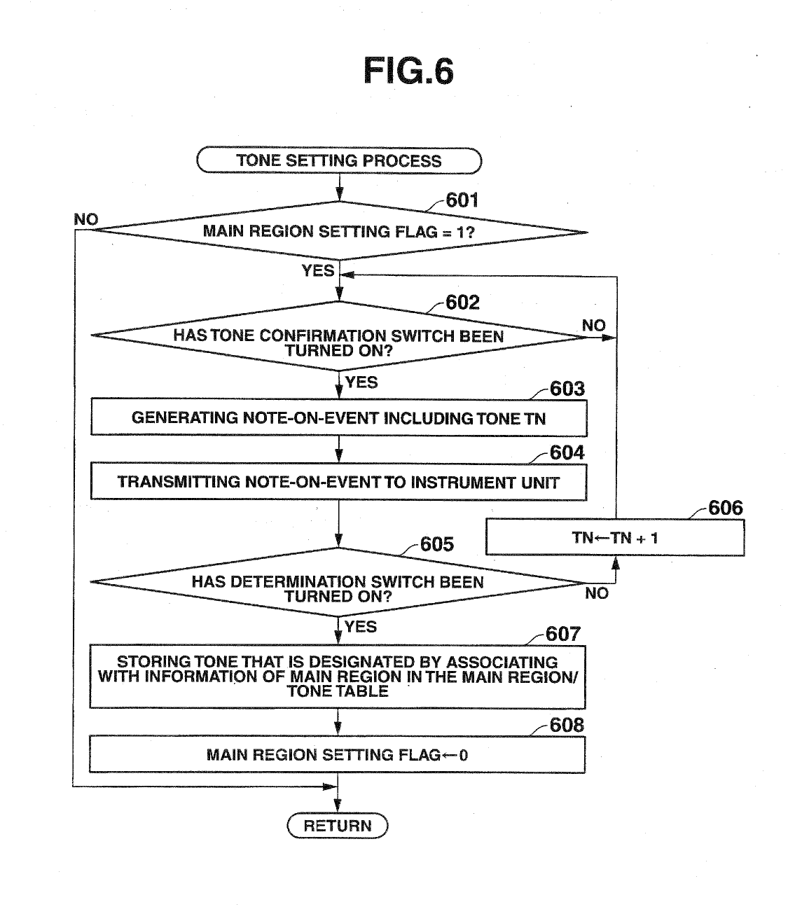

When the main region setting process in FIG. 3 (Step 305) ends, the CPU 21 executes a tone setting process (Step 306). FIG. 6 is a flowchart showing an example of the tone setting process according to the present embodiment. As shown in FIG. 6, the CPU 21 determines whether the main region setting flag is “1” (Step 601). In the case of a “No” determination in Step 601, the tone setting process ends.

In the case of a “Yes” determination in Step 601, the CPU 21 determines whether a tone confirmation switch is turned on (Step 602). In the case of a “Yes” determination in Step 602, the CPU 21 generates a Note-On-Event including tone information in accordance with a parameter TN indicating a tone (Step 603). This parameter TN is a tone number for identifying a tone uniquely, for example. Information indicating a sound volume level and a pitch may be predefined on this Note-On-Event. Then, the CPU 21 outputs the Note-On-Event thus generated to the I/F 26 (Step 604). The I/F 27 transmits the Note-On-Event to the infrared communication apparatus 24 as an infrared signal. The infrared signal from the infrared communication apparatus 24 is received by the infrared communication apparatus 33 of the instrument unit 19. In this way, a musical sound with a predetermined pitch is generated at the instrument unit 19. The generation of sound in the instrument unit 19 will be described later.

After Step 604, the CPU 21 determines whether a determination switch is turned on (Step 605). In the case of a “No” determination in Step 605, the parameter TN indicating the tone is incremented (Step 606) and the process flow returns to Step 602. In the case of a “Yes” determination in Step 605, the CPU 21 associates tone information indicating a parameter NN with information of the main region and stores the tone information in the main region/tone table in the RAM 26 (Step 607). Then, the CPU 21 resets the main region setting flag to “0” (Step 608).

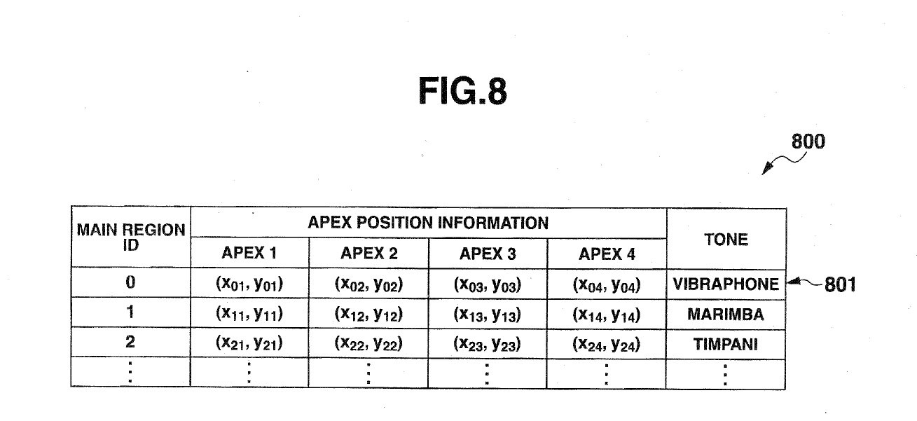

FIG. 8 is a diagram showing an example of the main region/tone table in the RAM 26 according to the present embodiment. As shown in FIG. 8, the record of a main region/tone table 800 according to the present embodiment (for example, refer to the reference numeral 801) includes the items of main region ID, coordinates of apex positions (apexes 1 to 4), and tones. The main region ID is intended for specifying a record uniquely and is numbered by the CPU 21 upon record generation of the main region/tone table 800. In the present embodiment, it is possible to designate the tone of an instrument with variable pitch. In the example of FIG. 8, the tone of percussion with variable pitch such as vibraphone, marimba, and tympani is set. It may be configured so that the tone of other instruments (such as a clavier, string, horn, and the like) other than the percussion can be set.

Furthermore, a two dimensional coordinate (x, y) in the x direction and y direction is stored as a coordinate of an apex position. As described above, this is because the main region according to the present embodiment is a three dimensional space defined by the surface based on four apexes and the perpendicular lines 75 to 78 extending from the four apexes, for example, and thus the z coordinate is arbitrary.

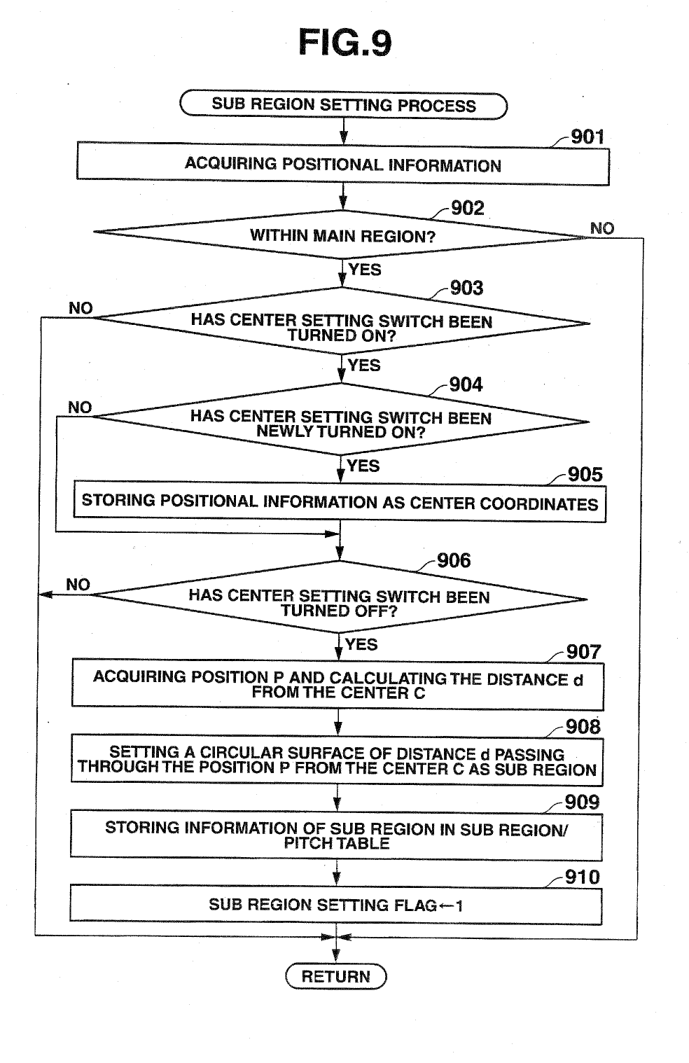

When the tone setting process in FIG. 3 (Step 306) ends, the CPU 21 executes a sub region setting process (Step 307). FIG. 9 is a flowchart showing an example of the sub region setting process according to the present embodiment. As shown in FIG. 9, the CPU 21 obtains positional information of the playing device main body 11 stored in the RAM 26 (Step 901), and determines whether the playing device main body 11 is positioned within any of the main region (Step 902). In the case of a “No” determination in Step 902, the sub region setting process ends.

In the case of a “Yes” determination in Step 902, the CPU 21 determines whether a center setting switch is turned on in the input unit 28 of the playing device main body 11 (Step 903). In the case of a “No” determination in Step 903, the sub region setting process ends. In the case of a “Yes” determination in Step 903, the CPU 21 determines whether the center setting switch has been newly turned on (Step 904). In the case of a “Yes” determination in Step 904, the CPU 21 stores the positional information of the playing device main body 11 as positional information of a center position C (coordinate (x_{c}, y_{c}, z_{c}) in the RAM 26 (Step 905). This position is a reference position of a sub region set below.

In the case of a “No” determination in Step 904, i.e. in the case of the switch being turned on or after Step 905 being executed, the CPU 21 determines whether the center setting switch is turned off (Step 906). In the case of a “No” determination in Step 906, the sub region setting process ends. In the case of a “Yes” determination in Step 906, the CPU 21 stores positional information of the playing device main body 11 in the RAM 26 as positional information of the position P (coordinate (xₚ, yₚ, zₚ)) of the playing device main body 11 when the center setting switch is turned off (Step 907). Furthermore, in Step 907, the CPU 21 calculates the distance dₚ between the position C and the position P. The CPU 21 determines, as a sub region, an area (a disc shape: a circular surface) with a radius dₚ passing through the position P and with the position C as a center position (Step 908), and stores, in a sub region/pitch table in the RAM 26, the information specifying the sub region (the coordinates of the center position C, coordinates of the position P (also referred to as “a passing position”), and the radius d) (Step 909). The information stored in the sub region/pitch table in Step 909 also includes a main region ID that specifies the main region to which the sub region belongs and a sub region ID that specifies the sub region. Then, the CPU 21 sets a sub region setting flag in the RAM 26 to “1” (Step 910).

As described above, in the first embodiment, a performer turns on the center setting switch of the playing device main body 11 at a position where the performer wishes to set as the center position C. With this state being maintained, the performer moves the playing device main body 11 to a position corresponding to a radius, and turns off the center setting switch at the position. In this way, with the position where the center setting switch was turned on as a center position C, it is possible to set, as a sub region, a circular surface of a radius d (d: a distance between the center position C and the position P) passing through the position P where the center setting switch was turned off.

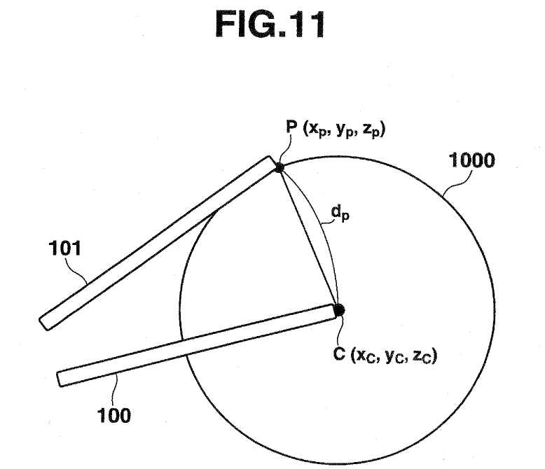

FIG. 11 is a diagram schematically showing the determination of a sub region according to the present embodiment. The reference numeral 100 indicates a playing device main body when the center setting switch is turned on, and the reference numeral 101 indicates a playing device main body when the center setting switch is turned off. For the sake of simplicity, FIG. 11 is illustrated in such a manner that the performer moves a playing device main body horizontally, and is established in a state being viewed from above.

By the performer turning on the center setting switch of the playing device main body, the position of the tip of the playing device main body 100 is stored in the RAM 26 as the coordinate (x_{c}, y_{c}, z_{c}) of the center position C. Then, with the center setting switch being turned on, when the performer moves the playing device main body 11 to a desired position and turns off the center setting switch, the position of the tip of the playing device main body 101 can be obtained as the coordinate (xₚ, yₚ, zₚ) of the position P and the distance dₚ between the center position C and the position P is calculated. In this way, a circular surface 1000 with the radius dₚ passing through the position P and with the center position C as its center is set as a sub region. As described later, a musical sound is generated by the tip of the playing device main body 11 (the geomagnetic sensor 22) being positioned on this sub region or passing through the sub region.

It should be noted that, in the example of FIG. 11, since the performer moves the playing device main body 11 horizontally, the circular surface is positioned parallel to the ground level. However, the present invention is not limited thereto and the circular surface set by the performer may be positioned at an arbitrary angle with respect to the ground level. In addition, another method may be employed for setting the region.

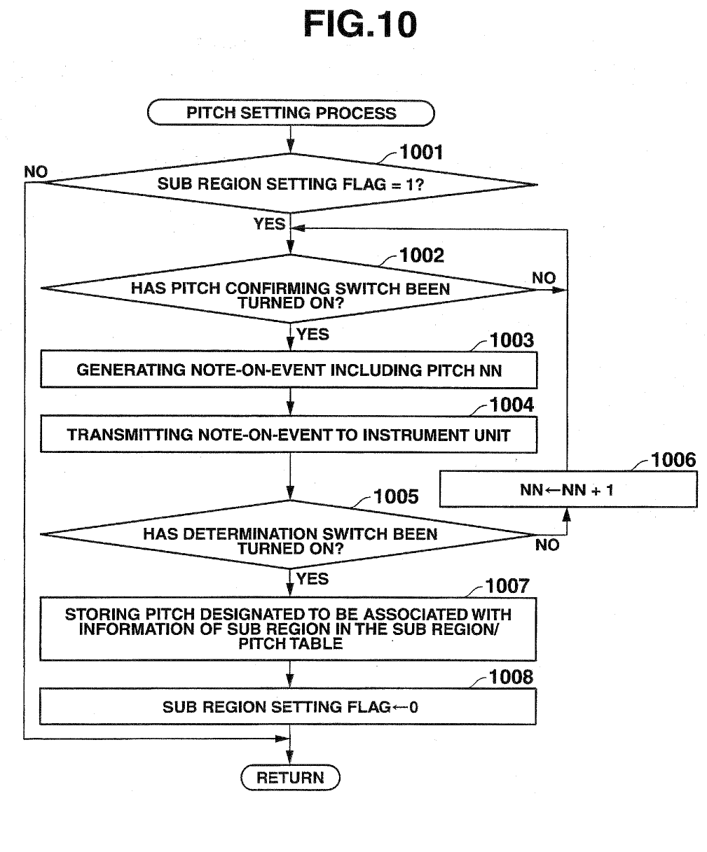

When the sub region setting process in FIG. 3 (Step 307) ends, the CPU 21 executes a pitch setting process (Step 308). FIG. 10 is a flowchart showing an example of a pitch setting process according to the present embodiment. It should be noted that, in order to designate a pitch, the input unit 28 includes a pitch confirming switch and a determination switch. This switch may be used by switching the other switch described above. Furthermore, the parameter for indicating a pitch used in the pitch setting process in FIG. 10 (for example, pitch information based on MIDI) is set to be an initial value (for example, the lowest pitch sound) in the initializing process (Step 301). As shown in FIG. 10, the CPU 21 determines whether the sub region setting flag is “1” (Step 1001). In the case of a “No” determination in Step 1001, the pitch setting process ends.

In the case of a “Yes” determination in Step 1001, the CPU 21 determines whether a pitch confirming switch is turned on (Step 1002). In the case of a “Yes” determination in Step 1002, the CPU 21 generates the Note-On-Event including pitch information in accordance with the parameter NN indicating a pitch (Step 1003). Information indicating the sound volume level and tone may be predefined on this Note-On-Event. Then, the CPU 21 outputs the Note-On-Event thus generated to the I/F 26 (Step 1004). The I/F 27 transmits the Note-On-Event to the infrared communication apparatus 24 as an infrared signal. The infrared signal from the infrared communication apparatus 24 is received by the infrared communication apparatus 33 of the instrument unit 19. In this way, a musical sound with a predetermined pitch is generated in the instrument unit 19.

After Step 1004, the CPU 21 determines whether a determination switch is turned on (Step 1005). In the case of a “No” determination in Step 1005, the CPU 21 increments the parameter NN indicating a pitch (Step 1006), and the process flow returns to Step 1002. In the case of a “Yes” determination in Step 1005, the CPU 21 associates pitch information indicating a parameter NN with information of the sub region and stores the pitch information in the sub region/pitch table in the RAM 26 (Step 1007). Then, the CPU 21 resets the sub region setting flag to “0” (Step 1008).

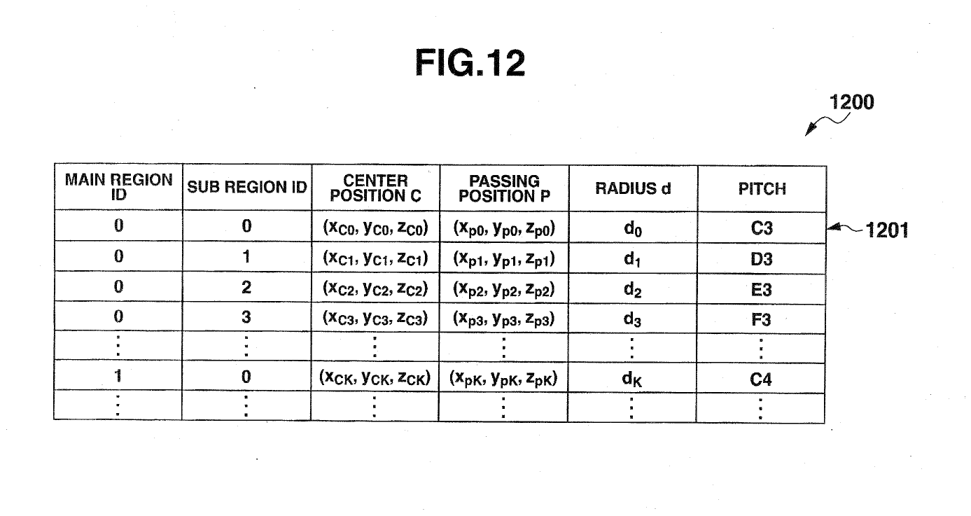

In the pitch setting process shown in FIG. 10, each time the pitch confirming switch is turned on, a musical sound of which the pitch is one higher than that of a previous musical sound is generated. When a musical sound with a desired pitch is generated, the performer turns on the determination switch which allows the performer to associate the desired pitch with a sub region. FIG. 12 is a diagram showing an example of a sub region/pitch table in the RAM according to the present embodiment. As shown in FIG. 12, a record of a sub region/pitch table 1200 according to the present embodiment (for example, refer to the reference numeral 1201) lists the items of the main region ID, sub region ID, coordinate of center position C, coordinate of passing position P, radius d, and pitch.

The main region ID specifies a main region in which the sub region is positioned. The sub region ID is numbered by the CPU 21 upon the generation of a record of the sub region/pitch table 1200.

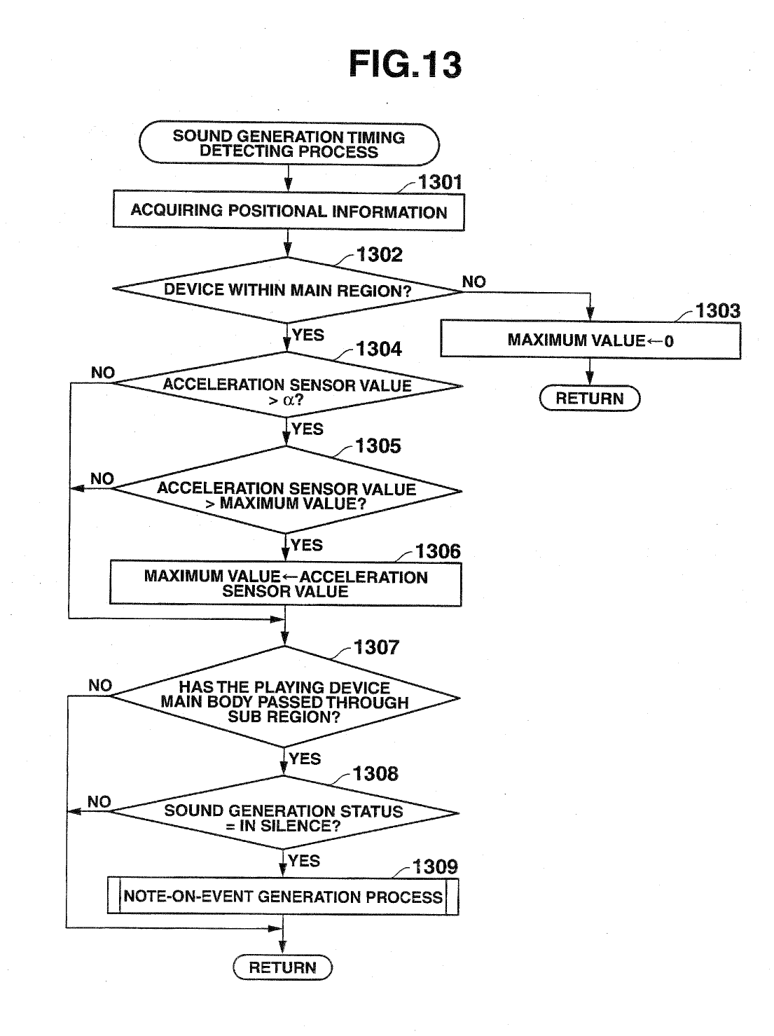

When the pitch setting process in FIG. 3 (Step 308) ends, the CPU 21 executes a sound generation timing detecting process (Step 309). FIG. 13 is a flowchart showing an example of the sound generation timing detecting process according to the present embodiment. The CPU 21 obtains positional information stored in the RAM 26 (Step 1301) and determines whether the playing device main body 11 is positioned within the main region by referring to the main region/tone table in the RAM 26 (Step 1302). In the case of a “No” determination in Step 1302, the maximum value of the acceleration sensor stored in the RAM 26 is reset to “0” (Step 1303).

In the case of a “Yes” determination in Step 1302, the CPU 21 determines whether the acceleration sensor value obtained in Step 302 is greater than a predetermined value a (Step 1304). The predetermined value a may be an arbitrary value greater than 0 and is acceptable so long as the playing device main body 11 being swung by a performer can be detected. In the case of a “No” determination in Step 1304, the process flow advances to Step 1307. In the case of a “Yes” determination in Step 1304, the CPU 21 determines whether the acceleration sensor value is greater than the maximum value stored in the RAM 26 (Step 1305). In the case of a “No” determination in Step 1305, the process flow advances to Step 1307.

In the case of a “Yes” determination in Step 1305, the CPU 21 stores the acceleration sensor value thus obtained as a maximum value in the RAM 26 (Step 1306). Then, the CPU 21 determines whether the position of the playing device main body 11 contacts the sub region or passes through the sub region (Step 1307). In Step 1307, the CPU 21 specifies a group of records having main region IDs of the main region which have been determined to be within the region in Step 1302 in the sub region/tone table, and obtains information specifying a circular surface that defines the sub region by way of referring to the coordinates of the center position C, coordinates of the passing position P, and the radius. Then, the CPU 21 determines whether the position of the playing device main body 11 which is presently obtained from the geomagnetic sensor 22 and the like, stored in the RAM 26, contacts the surface of the sub region or whether the trajectory of the playing device main body 11 obtained from the coordinate which has been previously processed or a coordinate which is presently processed, stored in the RAM 26, intersects with the surface of the sub region. In the case of a “No” determination in Step 1307, the sound generation timing detecting process ends.

In the case of a “Yes” determination in Step 1307, the CPU 21 determines whether a sound generation status which is associated with the sub region, stored in the RAM 26, is “in silence” (Step 1308). In the case of a “Yes” determination in Step 1308, the CPU 21 executes a Note-On-Event process (Step 1309). In the present embodiment, the sound generation status is associated with each of the sub regions and is stored in the RAM 26, and indicates that a tone associated with the sub region is in progress (the sound generation status is in progress or in silence (the sound generation status is in silence) at the sound source unit 31 of the instrument unit 19.

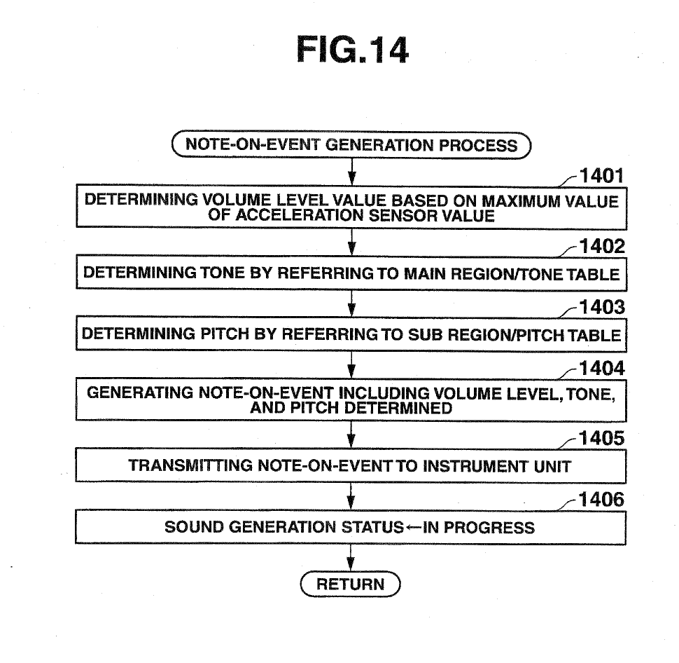

FIG. 14 is a flowchart showing an example of the Note-On-Event generation process according to the present embodiment. As shown in FIG. 14, the CPU 21 determines a sound volume level (velocity) based on a maximum value of an acceleration sensor value stored in the RAM 26 (Step 1401).

Provided that a maximum value of the acceleration sensor is Amax and a maximum value of the volume level (velocity) is Vmax, a sound volume level Vel can be calculated as follows, for example.

Vel=a·Amax

(provided that, if a·Amax>Vmax, Vel=Vmax, and a is a predetermined positive coefficient)

Then, the CPU 21 specifies a record of a main region where the playing device main body 11 is positioned by referring to the main region/tone table in the RAM 26, and determines the tone in the record thus specified as a tone of the musical sound to be generated (Step 1402). Furthermore, the CPU 21 specifies the record of a sub region which the playing device main body contacts or through which the playing device main body passes in the main region where the playing device main body 11 is positioned by referring to the sub region/pitch table in the RAM 23, and determines the pitch in the record thus specified as the pitch of the musical sound to be generated (Step 1403). The CPU 21 generates a Note-On-Event including the sound volume level (velocity), tone, and pitch thus determined (Step S1404).

The CPU 21 outputs the Note-On-Event thus generated to the I/F 27 (Step 1405). The I/F 27 transmits the Note-On-Event to the infrared communication apparatus 24 as an infrared signal. The infrared signal from the infrared communication apparatus 24 is received by the infrared communication apparatus 33 of the instrument unit 19. Then, the CPU 21 changes its sound generation status in the RAM 26 to “in progress” (Step 1406).

When the sound generation timing detecting process (Step 309) in FIG. 3 ends, the CPU 21 executes a parameter communicating process (Step 310). The parameter communicating process (Step 310) will be explained along with a parameter communicating process of the instrument unit 19 described later.

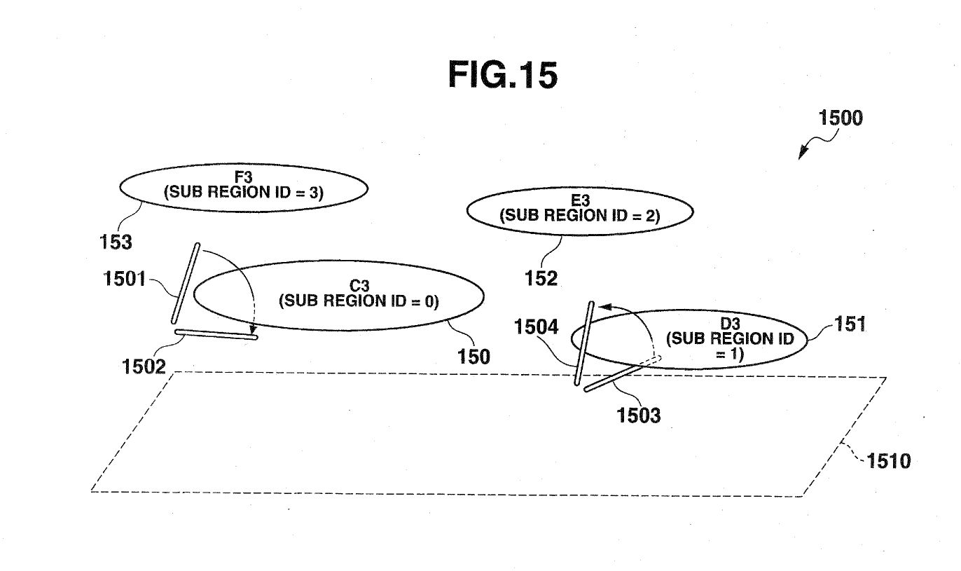

FIG. 15 is a diagram schematically showing an example of a sub region and a corresponding pitch that are set in the sub region setting process and the pitch setting process of the playing device main body according to the present embodiment. In this example, in the sub region setting process, sub regions (refer to the reference numerals 150 to 153) are set in a main region (refer to the reference numeral 1500) that is defined by a projected surface 1510 and perpendicular lines extending from the apexes thereof. Sub region IDs of the sub regions 150 to 153 are “0” to “3”, respectively, and each of the sub regions 150 to 153 is assigned a pitch from C3 to F3. The information is stored in the sub region/pitch table in the RAM 26.

For example, when the performer swings down a playing device main body (the reference numeral 1501) and the tip of the playing device main body (refer to the reference numeral 1502) passes through the sub region 150, a musical sound with a pitch of C3 is generated. Similarly, when the player swings up the playing device main body (refer to the reference numeral 1503) and the tip of the playing device main body (refer to the reference numeral 1504) passes through the sub region 151, a musical sound with a pitch of D3 is generated. It should be noted that a tone is associated with the main region 1500.

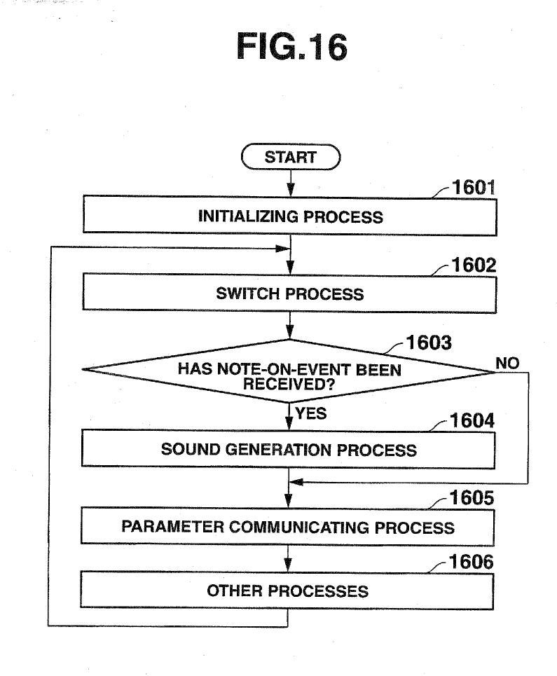

FIG. 16 is a flowchart showing an example of processes executed in the instrument unit according to the present embodiment. The CPU 12 of the instrument unit 19 (FIG. 1) executes an initializing process including, for example, clearing data in the RAM 15, clearing an image on a screen of the display unit 16, and clearing the sound resource unit 31 (Step 1601). Then, the CPU 21 executes a switch process (Step 1602). In the switch process, the CPU 21 sets a parameter of a sound effect for a musical sound to be generated in accordance with a switch operation of the input unit 17, for example. The parameter for the sound effect thus set (for example, depth of reverberation) is stored in the RAM 15. Furthermore, in the switch process, it is also possible to edit by way of a switch operation the main region/tone table and the sub region/pitch table, which are transmitted from the playing device main body 11 by way of a parameter communicating process described later, and stored in the RAM 15 of the instrument unit 19. In this edit, it is also possible to modify an apex position defining a main region, to change the tone, to modify the position or size of a sub region, or to change the pitch.

Then, the CPU 12 determines whether the I/F 13 has newly received a Note-On-Event (Step 1603). In the case of a “Yes” determination in Step 1603, the CPU 12 executes a sound generation process (Step 1604). In the sound generation process, the CPU 12 outputs the Note-On-Event thus received to the sound source unit 31. The sound source unit 31 reads waveform data of ROM in accordance with a tone included in the Note-On-Event. Furthermore, the read rate thereof follows the pitch that is included in the Note-On-Event. Furthermore, the sound source unit 31 multiplies the waveform data thus read by a coefficient in accordance with sound volume data (velocity) included in the Note-On-Event to generate musical sound data with a predetermined sound volume level. The musical sound data thus generated is output to an audio circuit 32 and a given musical sound is ultimately generated from the speaker 35.

Then, the CPU 12 executes a parameter communicating process (Step 1605). In the parameter communicating process (Step 1605), data in the main region/tone table and the sub region/pitch table that is edited in the switch process (Step 1602) is transmitted to the playing device main body 11 in accordance with the instruction from the CPU 12. In the playing device main body 11, when the infrared communication apparatus 24 receives data, the CPU 21 receives the data via the I/F 27 and stores it in the RAM 26 (Step 310 in FIG. 3).

In Step 310 of FIG. 3 as well, the CPU 21 of the playing device main body 11 executes the parameter communicating process. In the parameter communicating process of the playing device main body 11, the data of the main region/tone table and the sub region/pitch table generated based on the main region and the tone and the sub region and the pitch set in Steps 305 to 308 and stored in the RAM 26 are transmitted to the instrument unit 19.

When the parameter communicating process (Step 1605) of the instrument unit 19 ends, the CPU 12 executes other processes such as updating an image displayed on the screen of the display unit 16 (Step 1606).

According to the first embodiment, the sound generation timing is set when the playing device main body 11 is positioned within the main region as well as the position thereof is positioned in the sub region, and the CPU 21 generates a Note-On-Event with the tone stored in the main region/tone table and associated with the main region and the pitch stored in the sub region/pitch table and associated with the sub region. The performer can thereby generate a musical sound with a desirable tone and pitch by manipulating the playing device main body 11 toward a predetermined sub region in a main region set for a predetermined tone.

Furthermore, in the present embodiment, based on the positional information of at least three apexes, a surface formed by connecting these apexes being projected onto ground level is set as a bottom surface. Then, the CPU 21 determines a space defined by the bottom surface and the perpendicular lines extending from these apexes as a main region. In this way, the CPU 21 can set the main region based on the surface connecting the apexes by the performer designating the apexes. It should be noted that, although the main region is set as a surface with four apexes (a quadrangle) in the present embodiment, it is also possible to set a main region of an arbitrary bottom shape such as a triangle by changing the number of apexes.

Furthermore, in the present embodiment, based on the positional information of the designated center position and the positional information of another position different from the center position, the CPU 21 sets the center position as a center and specifies a circular surface passing through the other position as a sub region. It is thereby possible for the CPU 21 to set the circular two-dimensional surface as a sub region by designating the center position and the other position (passing position).

Furthermore, in the present embodiment, the playing device main body 11 includes the geomagnetic sensor 22 and the acceleration sensor 23, and the CPU 21 detects a movement direction of the playing device main body 11 based on the sensor value of the geomagnetic sensor 22 as well as calculates the displacement of the playing device main body 11 based on a sensor value of the acceleration sensor 23. The current position of the playing device main body 11 is obtained based on the movement direction and the displacement.

It is thereby possible for the present embodiment to obtain the position of the playing device main body 11 without employing a large-sized apparatus and without complex calculation.

Next, a second embodiment of the present invention will be explained. In the first embodiment, a region defined by a surface formed from a polygon connecting a plurality of apexes being projected to a ground level and the perpendicular lines extending from the apexes is set as a main region. Furthermore, a circular surface region defined by a center position and a radius is set as a sub region. However, the shapes of the regions are not limited thereto.

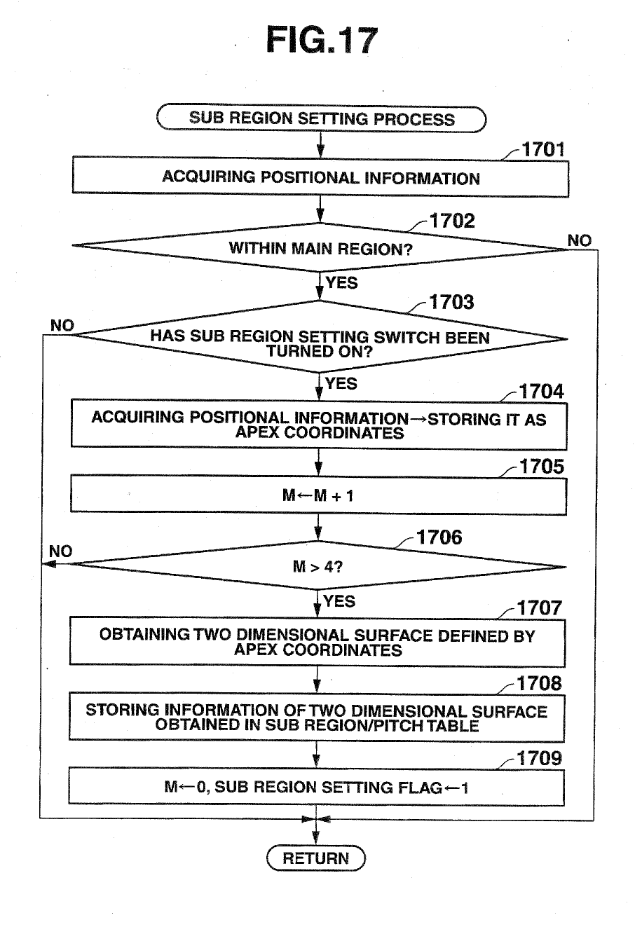

For example, in the second embodiment, a polygonal surface region connecting a plurality of apexes is set. FIG. 17 is a diagram showing an example of a sub region setting process according to the second embodiment. In the second embodiment, processes other than the sub region setting process (for example, the main region setting process, the tone setting process, the pitch setting process, the sound generation timing detecting process, and the like) are similar to those in the first embodiment.

As shown in FIG. 17, the CPU 21 obtains positional information of the playing device main body 11 stored in the RAM 26 (Step 1701) and determines whether the playing device main body 11 is positioned within any part of the main region (Step 1702). In the case of a “No” determination in Step 1702, the sub region setting process ends.

In the case of a “Yes” determination in Step 1702, the CPU 21 determines whether the sub region setting switch in the input unit 18 is turned on (Step 1703). In the case of a “Yes” determination in Step 1703, the CPU 21 obtains the positional information stored in the RAM 26 and stores it as the coordinate of an apex (apex coordinate) in the RAM 26 (Step 1704). Then, the CPU 21 increments a parameter M indicating the number of apexes in the RAM 26 (Step 1705). It should be noted that, similar to the first embodiment, the parameter M is initialized to be “0” in the initializing process (Step 301 of FIG. 3). Then, the CPU 21 determines whether the parameter M is greater than “4” (Step 1706). In the case of a “No” determination in Step 1706, the sub region setting process ends.

The case of a “Yes” determination in Step 1706 means that the four apexes coordinates are stored in the RAM 26. Therefore, in the case of a “Yes” determination in Step 1706, the CPU 21 obtains information of a two dimensional surface (a quadrangle) that is demarcated by the four apexes coordinate (Step 1707). Then, the CPU 21 stores the two-dimensional surface information thus obtained in the sub region/pitch table in the RAM 26 (Step 1708). Subsequently, the CPU 21 initializes the parameter M in the RAM 26 to “0” and sets the sub region setting flag to “1” (Step 1709).

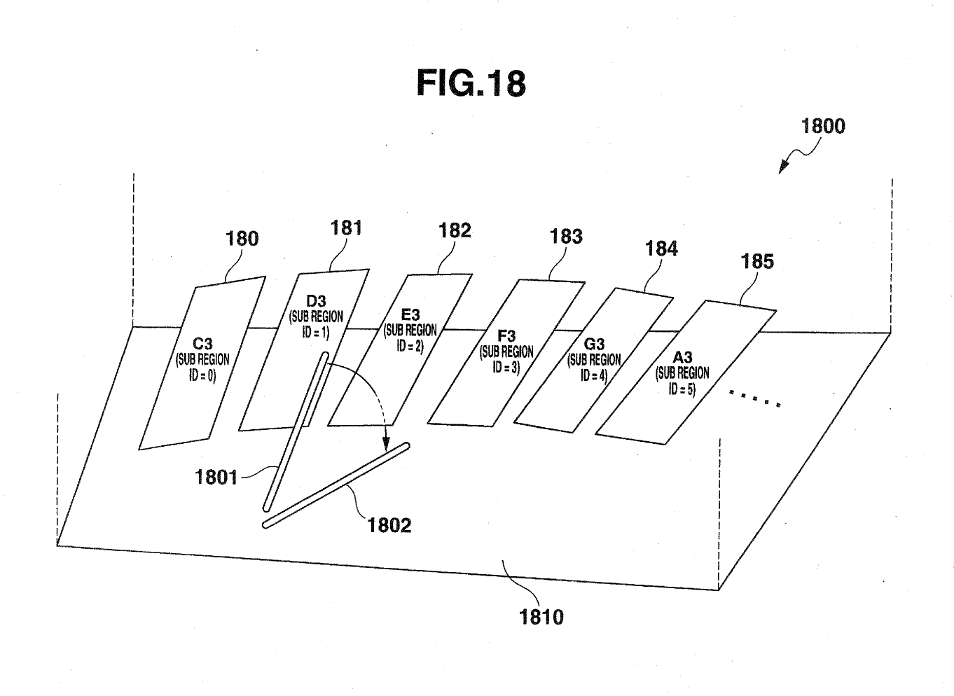

In this way, according to the second embodiment, the sub region that is a two-dimensional surface defined by a plurality of apexes (in the present embodiment, four apexes) can be set. Similar to the first embodiment, a desired pitch can be set in each of the sub regions by way of the pitch setting process. FIG. 18 is a diagram schematically showing an example of a sub region and a corresponding pitch that are set in the sub region setting process and the pitch setting process of the playing device main body according to the present embodiment. In this example, a quadrangle demarcated by four apexes is set as a sub region in the sub region setting process. In FIG. 18, six sub regions 180 to 185, each of which is a quadrangle, are exemplified in the main region (refer to the reference numeral 1800) demarcated by a projection 1810 and the perpendicular lines extending the apexes thereof. Sub region IDs of the sub regions 180 to 185 are “0” to “5”, respectively. Furthermore, each of the sub regions 180 to 185 is assigned a pitch from C3 to A3. The information is stored in the sub region/pitch table in the RAM 26. For example, when the performer swings down the playing device main body (the reference numeral 1801) and the tip of the playing device main body (refer to the reference numeral 1802) passes through the sub region 182, a musical sound with a pitch of E3 is generated.

Furthermore, similar to the first embodiment, the playing device main body may obtain a circular two-dimensional surface based on the center position C and the radius d as the main region and may set a region demarcated by a projected surface formed by projecting the circular two-dimensional surface onto the ground level and the perpendicular lines extending from the projected surface.

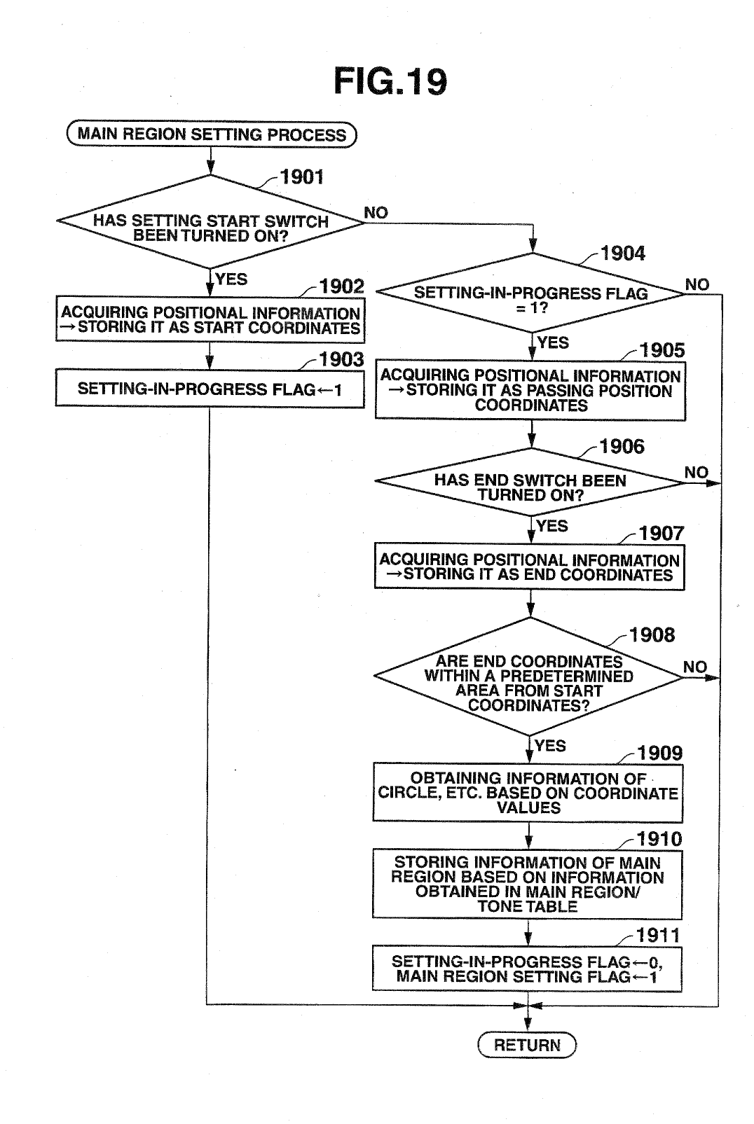

Furthermore, it is also possible to obtain circular or elliptical surface information not by acquiring the surface information by acquiring the center position and the radius, but rather by the performer moving the playing device main body 11 along a desirable region in a space. In the following, a case in which the main region is set based on a trajectory of the playing device main body 11 will be explained as a third embodiment. Also in the third embodiment, a column-shaped main region with its bottom surface being in a circular shape (or an elliptical shape) is set. That is to say, in the third embodiment, by the performer moving the playing device main body 11 along a desired region in a space, the playing device main body 11 defines a circular or an elliptical surface, and a projected surface of the surface thus demarcated onto the ground level becomes a bottom surface of the circular column (or the elliptical column) defining the main region. FIG. 19 is a flowchart showing an example of the main region setting process according to the third embodiment. In the third embodiment, the switch unit 28 of the playing device main body 11 includes a setting start switch and a setting end switch for setting the main region. It should be noted that, in the third embodiment, processes other than the main region setting process (for example, the tone setting process, the sub region setting process, the pitch setting process, the sound generation timing detecting process, and the like) are similar to those in the first embodiment.

As shown in FIG. 19, the CPU 21 determines whether the setting start switch is turned on (Step S1901). In the case of a “Yes” determination in Step 1901, the CPU 21 obtains positional information stored in the RAM 26, and stores it as the coordinates of a start position (start coordinates) in the RAM 26 (Step 1902). Furthermore, the CPU 21 sets a setting-in-progress flag to “1” (Step 1903).

In the case of “No” determination in Step 1901, the CPU 21 determines whether the setting-in-progress is “1” (Step 1904). In the case of a “Yes” determination in Step 1704, the CPU 21 obtains the positional information stored in the RAM 26, and stores it as the coordinates of a passing position (passing position coordinates) in the RAM 26 (Step 1905). It should be noted that Step 1905 is executed a plurality of times until the end switch of the playing device main body 11 is turned on by the performer. Therefore, in Step 1905, the number of times Step 1705 is executed and the passing position coordinates are stored in the RAM 26.

Then, the CPU 21 determines whether the end switch is turned on (Step 1906). In the case of a “Yes” determination in Step 1906, the CPU 21 obtains the positional information stored in the RAM 26 and stores it as the coordinates of an end position (end coordinates) in the RAM 26 (Step 1907). Then, the CPU 21 determines whether the end coordinates are positioned within a predetermined area from the start coordinates (Step 1908). In the case of a “No” determination in Step 1908, the region setting process ends. In the case of a “No” determination in Step 1904 and 1906 as well, the region setting process ends in a similar way.

In the case of a “Yes” determination in Step 1908, based on the start coordinate, the passing position coordinate, and the end position coordinate, the CPU 21 obtains information that specifies an ellipse or a circle that passes through these coordinates (Step 1909). The CPU 21 may make a closed curve that connects adjacent coordinates and obtain a circle or an ellipse that approximates this closed curve. For example, in the approximation, a well-known method such as a least-square method can be applied. Furthermore, the CPU 21 calculates information of an ellipse or a circle that corresponds to a projected surface formed by projecting the ellipse or the circle specified in Step 1909 onto the ground level, and stores it in the main region/tone table in the RAM 26 as the information of the main region (Step 1910). Then, the CPU 21 resets the setting-in-progress flag in the RAM 26 to “0” and set the main region setting flag to be “1” (Step 1911).

According to the third embodiment, the main region in a column shape demarcated by the projected surface formed by projecting the surface in a desired surface set by the performer and the perpendicular lines extending from the projected surface can be set. Specifically, in the third embodiment, the main region, such as that in which a trajectory on which the playing device main body 11 is made to move by the performer is set as a lateral side of an outer profile, can be set. It should be noted that the sub region can be set by way of the method described in the third embodiment.

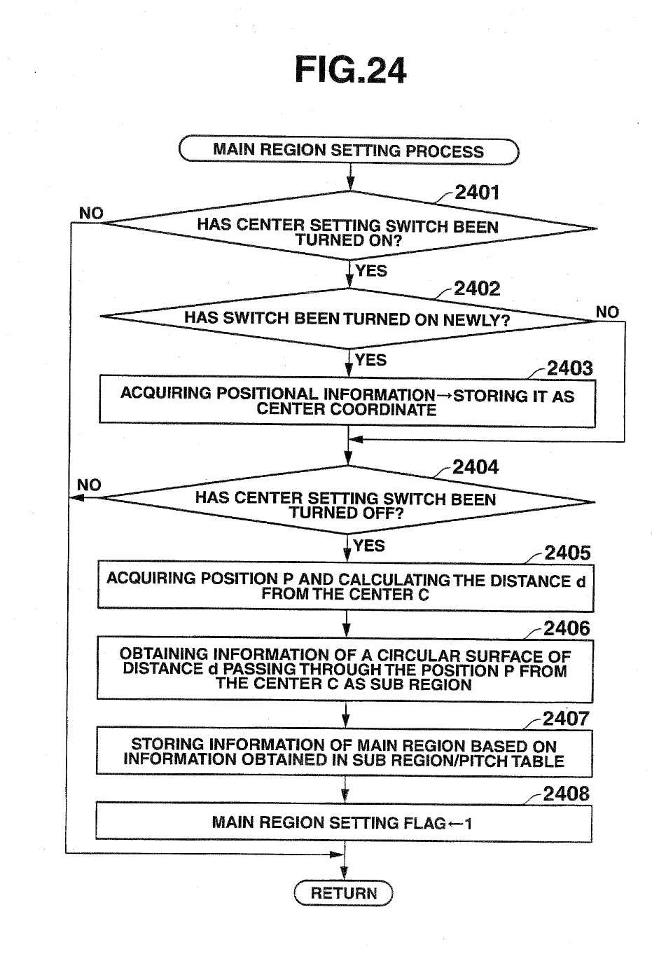

Furthermore, the setting of a main region is not limited to the method based on the trajectory of the playing device main body 11. For example, similar to the setting of the sub region in the first embodiment, by obtaining a circular two-dimensional surface based on the center position C and the radius d, a region defined by a projected surface projecting the circular two-dimensional surface onto the ground level and perpendicular lines extending from the projected surface may be set. This will be explained later with reference to FIG. 24.

Next, a fourth embodiment of the present invention will be explained. In the fourth embodiment, when the performer sets a single region in the main region, the region is divided into a predetermined number of pieces, which are set as sub regions respectively and assigned a pitch automatically.

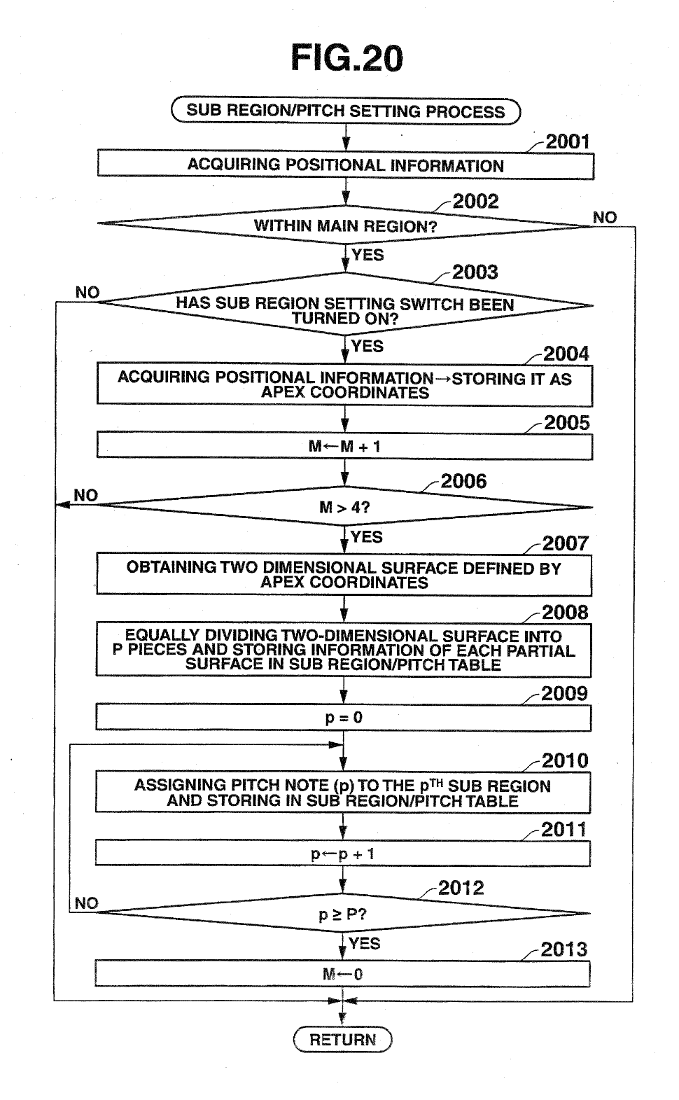

In the fourth embodiment, a sub region/pitch setting process is executed in place of the sub region setting process (Step 307) and the pitch setting process (Step 308) in FIG. 3. FIG. 20 is a flowchart showing an example of a sub region/pitch setting process according to the fourth embodiment. As shown in FIG. 20, the CPU 21 obtains positional information of the playing device main body 11 stored in the RAM 26 (Step 2001) and determines whether the playing device main body 11 is positioned within any part of the main region (Step 2002). In the case of a “No” determination in Step 2002, the sub region/pitch setting process ends.

In the case of a “Yes” determination in Step 2002, the CPU 21 determines whether a sub region setting switch in the input unit 18 is turned on (Step 2003). In the case of a “Yes” determination in Step 2003, the CPU 21 obtains the positional information stored in the RAM 26 and stores it as the coordinates of the apex (apex coordinate) in the RAM 26 (Step 2004). Then, the CPU 21 increments a parameter M indicating the number of apexes (Step 2005). It should be noted that, similar to the first embodiment, the parameter M is initialized to be “0” in the initializing process (Step 301 of FIG. 3). Then, the CPU 21 determines whether the parameter M is greater than “4” (Step 2006). In the case of a “No” determination in Step 2006, the sub region setting process ends.

The case of a “Yes” determination in Step 2006 means that four apex coordinates are stored in the RAM 26. Therefore, in the case of a “Yes” determination in Step 2006, the CPU 21 obtains information of a two dimensional surface that is defined by the four apex coordinates(quadrangle) (Step 2007). Then, the CPU 21 equally divides the two-dimensional surface thus obtained into P pieces to acquire the respective positional information (information of the four apex coordinates) of the P pieces of partial surfaces. The CPU 21 stores the positional information of each of the partial surfaces thus obtained in the sub region/pitch table in the RAM 26 as sub region information (Step 2008).

Then, the CPU 21 initializes a parameter p to “0” (Step 2009), and assigns a predetermined pitch Note(p) to the pth sub region (the sub region ID=p), associates it with the sub region ID in the sub region/pitch table, and stores the pitch Note(p) (Step 2010). The CPU 21 increments the parameter p (Step 2011) and determines whether the parameter p is not less than P (Step 2012). In the case of a “No” determination in Step 2012, the process flow returns to Step 2010. In the case of a “Yes” determination in Step 2012, the CPU 21 initializes the parameter M in the RAM 26 to “0” (Step 2013).

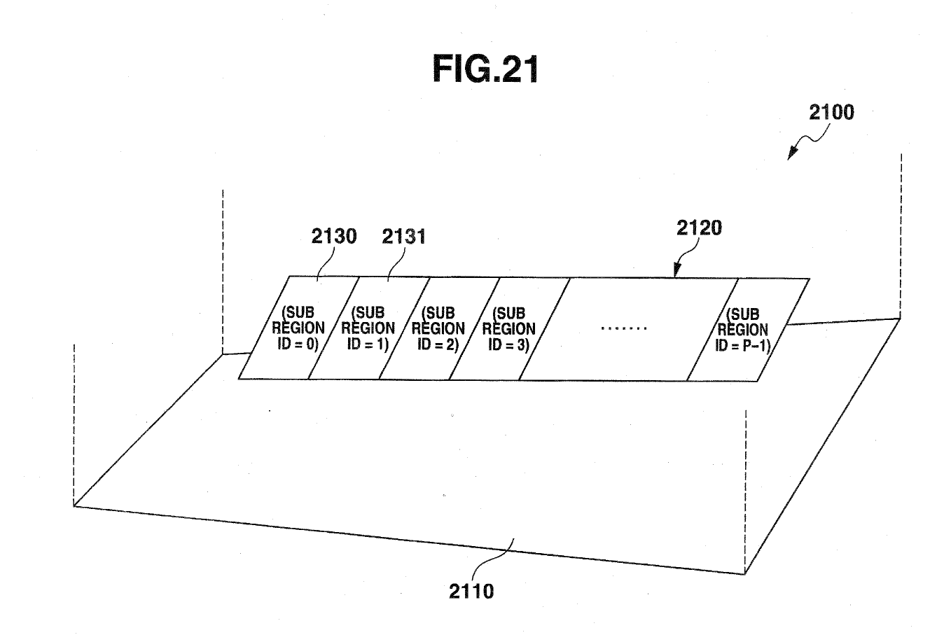

FIG. 21 is a diagram schematically showing a sub region set in the sub region/pitch setting process of the playing device main body according to the present embodiment. As shown in FIG. 21, a two-dimensional surface 2120 is set within the main region (refer to the reference numeral 2100) demarcated by a projected surface 2110 and perpendicular lines respectively extending from apexes. By the sub region/pitch setting process, the two-dimensional surface 2120 is divided into p pieces of partial surfaces (for example, refer to the reference numerals 2130 and 2131), and a sub region ID and a corresponding a pitch Note(p) is assigned to each of the partial surfaces, respectively. The information (apex coordinate) of the sub region and the pitch are each associated with a sub region ID and stored in the sub region/pitch table.

According to the fourth embodiment, when the two dimensional surface is set in the main region by the performer operating the playing device main body 11, the two dimensional surface is divided and a predetermined number of sub regions is generated. Then, the positional information of the sub regions is stored in the sub region/pitch table and a pitch to be assigned to each sub region is also stored in the sub region/pitch table. In this way, the setting of the desired sub regions is completed by a simple operation of the performer.

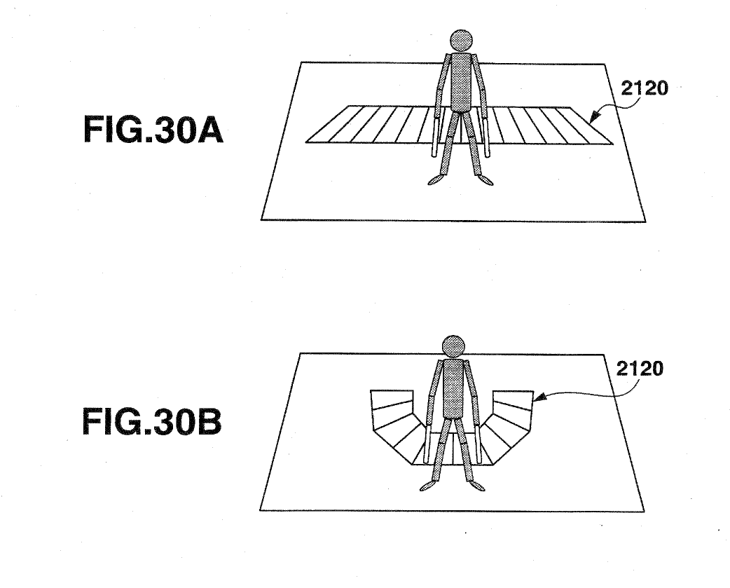

According to this fourth embodiment, it becomes possible to virtually produce instruments, such as a xylophone, metallophone, and the like, in which the struck bodies corresponding to different pitches are aligned, in a space (for example, FIG. 30A).

However, the shape of the two-dimensional surface of the sub region 2120 can be changed so as to facilitate performance for the performer. For example, as shown in FIG. 30B, it may be configured to be in a multiangular shape so as to surround the performer.

In the abovementioned first embodiment to fourth embodiment, the tone of the musical sound to be generated is set by being associated with the main region and the pitch of the musical sound to be generated is set by being associated with each of the sub regions. In a fifth embodiment, a first tone corresponding to a tone category is set by being associated with a main region, and a second tone corresponding to a sub category, which is more detailed than the first tone, is set by being associated with a sub region.

In the fifth embodiment, mostly the same processes as those in the first embodiment are executed, except for the aspect of a second tone setting process being executed in place of the tone setting process of Step 308 in FIG. 3. Specifically, in the fifth embodiment, the first tone falls in a percussion and the second tone falls in a hi-hat, snare, bass drum, toms, cymbal, and the like, which are included in the category of percussion. Furthermore, in the tone setting process in FIG. 6, a musical sound of any of the second tones (for example, a snare) included in the category of percussion just needs to be generated.

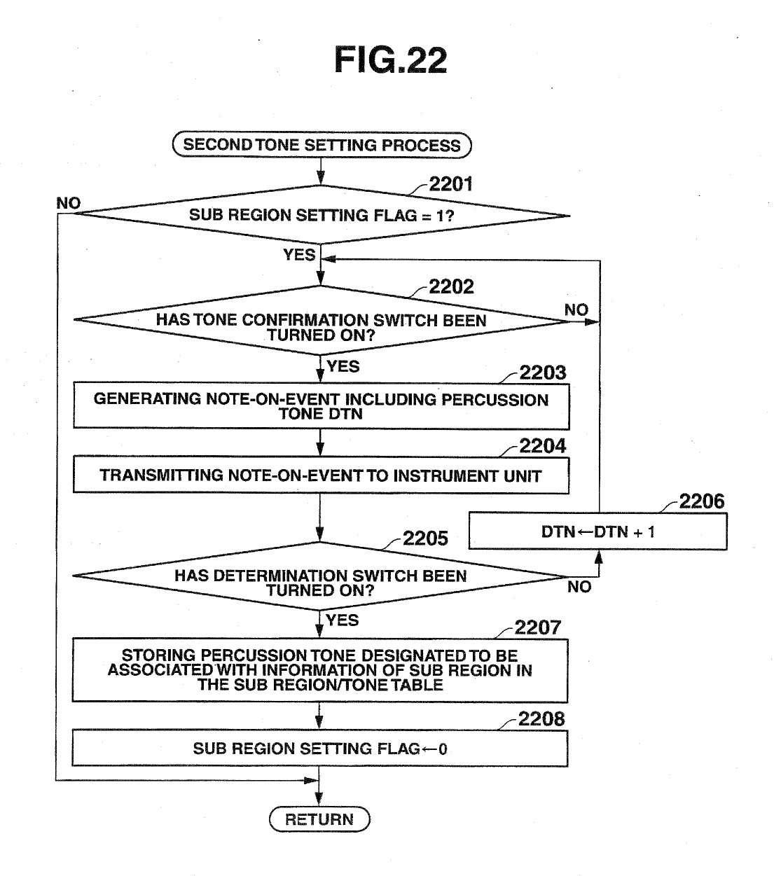

FIG. 22 is a flowchart showing an example of a second tone setting process according to the fifth embodiment. As shown in FIG. 22, the CPU 21 determines whether the sub region setting flag is “1” (Step 2201). In the case of a “No” determination in Step 2201, the second tone setting process ends.

In the case of a “Yes” determination in Step 2201, the CPU 21 determines whether the tone confirmation switch is turned on (Step 2202). In the case of a “Yes” determination in Step 2202, the CPU 21 generates a Note-On-Event including tone information in accordance with a parameter DTN indicating a tone of percussion (Step 2203). This parameter DTN is a tone number for uniquely specifying a tone of percussion, for example. For this Note-On-Event, the information indicating the sound volume level or pitch only needs to be predefined. Then, the CPU 21 outputs the Note-On-Event thus generated to the I/F 26 (Step 2204). The I/F 27 transmits the Note-On-Event to the infrared communication apparatus 24 as an infrared signal. The infrared signal from the infrared communication apparatus 24 is received by the infrared communication apparatus 33 of the instrument unit 19. In this way, a musical sound with a predetermined pitch is generated in the instrument unit 19.

After Step 2204, the CPU 21 determines whether a determination switch is turned on (Step 2205). In the case of a “No” determination in Step 2205, the CPU 21 increments the parameter DTN indicating a tone (Step 2206,) and the process flow returns to Step 2202. In the case of a “Yes” determination in Step 2205, the CPU 21 associates tone information indicating a parameter DTN with information of the sub region, and stores the tone information in the sub region/tone table in the RAM 26 (Step 2207). Then, the CPU 21 resets the sub region setting flag to “0” (Step 2208).

In the fifth embodiment, the sub region/tone table is provided in the RAM 26 in place of the sub region/pitch table. An item of the second tone associated with percussion is provided in place of the item of the pitch in the sub region/pitch table shown in FIG. 12.

According to the fifth embodiment, a region in which a second tone can be set is set as a main region, and a sub region is set within the main region to assign various second tones to these sub regions.

Although the first to fifth embodiments of the present invention are explained above, the present invention is not to be limited thereto. For example, it is possible to combine the first to fifth embodiments. In such a combined embodiment, in a case that a tone of an instrument of which the pitch can be altered, such as a vibraphone and marimba, is assigned to the main region in the tone setting process shown in FIG. 6, the pitch setting process (refer to FIG. 10) is executed following the sub region setting process (refer to FIG. 9). On the other hand, in a case of the tone of percussion being set in the main region, the second tone setting process (refer to FIG. 22) is executed following the sub region process (refer to FIG. 9). In this embodiment, the CPU 21 only needs to determine whether the tone set in the tone setting process (FIG. 6) is a tone of percussion or another tone after the sub region setting process.

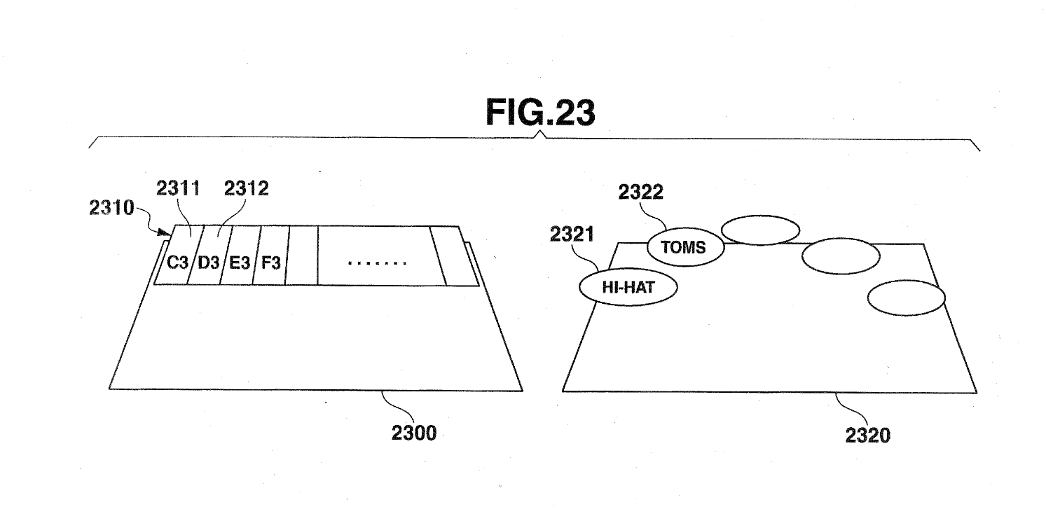

FIG. 23 is an example schematically showing a main region and sub regions of the combined embodiment. A main region and sub regions that are set in accordance with the fourth embodiment on the left side in FIG. 23, and a main region and sub regions that are set in accordance with the fifth embodiment on the right side in FIG. 23. On the left side, a region 2310 set by a performer is included in a main region 2300 and furthermore, the region 2310 is divided into a plurality of regions, each surface of which thus divided is set as sub regions, respectively (refer to the reference numerals 2311 and 2312). Furthermore, a predetermined pitch is assigned to the respective sub regions.

On the other hand, on the right side, a plurality of sub regions (refer to the reference numeral 2321 and 2322) is set in a main region 2320 and various second tones, which are sub categories for percussion, are set thereto, respectively.

While the performer is positioned within the main region 2300, when the playing device main body 11 is positioned in a sub region, a musical sound with a pitch that is assigned to the sub region and with a tone (for example, vibraphone) assigned to the main region 2300 is generated. On the other hand, while the performer is positioned within the main region 2320, when the playing device main body 11 is positioned in a sub region, a musical sound with the second tone that is assigned to the sub region is generated. In this way, it is possible to realize a virtual performance of different instruments by moving to different main regions.

Furthermore, it is also possible to apply other methods for setting the main region and sub regions. FIG. 24 is a flowchart showing an example of a main region setting process according to the other embodiments. The example of FIG. 24 is almost the same as the setting of sub regions shown in FIG. 9, in which a center position C and a passing position P are set, and a circular two-dimensional surface passing through the passing position P with the center position C being a center thereof is obtained, a result of which a main region is set based on the abovementioned method.

The CPU 21 determines whether a center setting switch is turned on in the input unit 28 of the playing device main body 11 (Step 2401). In the case of a “No” determination in Step 2401, the main region setting process ends. In the case of a “Yes” determination in Step 2401, the CPU 21 determines whether the center setting switch is newly turned on (Step 2402). In the case of a “Yes” determination in Step 2402, the CPU 21 stores positional information of the playing device main body 11 as the positional information of a center position C (coordinates (x_{c}, y_{c}, and z_{c}) in the RAM 26 (Step 2403). This position is a reference position of a main region and sub region set below.

In the case of a “No” determination in Step 2402, i.e. in the case of the switch being turned on, or after Step 2403 is executed, the CPU 21 determines whether the center setting switch is turned off (Step 2404). In the case of a “No” determination in Step 2404, the sub region setting process ends. In the case of a “Yes” determination in Step 2404, the CPU 21 stores the positional information of the playing device main body 11 in the RAM 26 as the positional information of the position P (coordinates (xₚ, yₚ, zₚ)) of the playing device main body 11 when the center setting switch is turned off (Step 2405). Furthermore, in Step 2405, the CPU 21 calculates the distance dₚ between the position C and the position P. The CPU 21 obtains information of a circular surface with a radius dₚ passing through the position P and with the position C as a center position (Step 2406). Then, the CPU 21 stores information of the main region based on the information thus obtained in the main region/tone table in the RAM 26 (Step 2407). Then, the CPU 21 sets a main region setting flag in the RAM 26 to “1” (Step 2408).

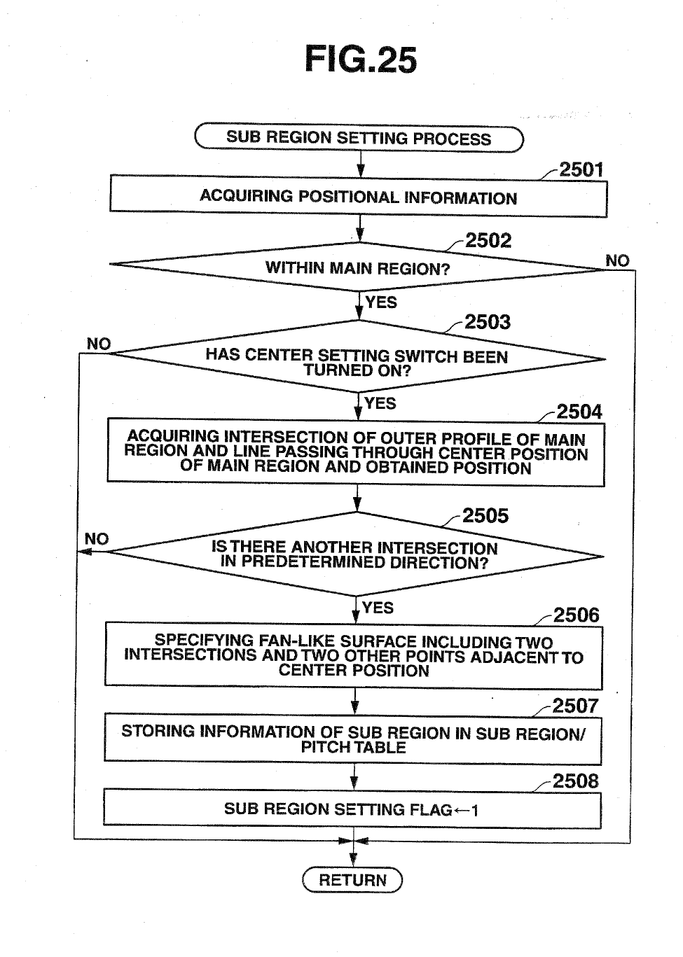

Next, a sub region setting process according to an alternative embodiment will be explained. FIG. 25 is a flowchart showing a sub region setting process according to the alternative embodiment. As shown in FIG. 25, the CPU 21 obtains positional information of the playing device main body 11 stored in the RAM 26 (Step 2501), and determines whether the playing device main body 11 is positioned within any part of the main region (Step 2502). In the case of a “No” determination in Step 2502, the sub region setting process ends.

In the case of a “Yes” determination in Step 2502, the CPU 21 determines whether a center setting switch is turned on in the input unit 28 of the playing device main body 11 (Step 2503). In the case of a “Yes” determination in Step 2503, the CPU 21 obtains the coordinates of an intersection of an outer profile of the main region and the line passing through the center position C stored in the main region/tone table in the RAM 26, as well as the position of the playing device main body 11 obtained in Step 2501 (Step 2504). The coordinates of the intersection is stored in the RAM 26. The CPU 21 determines whether information of another intersection that is positioned in a predetermined angle direction with respect to the line passing through the abovementioned center and the position of the playing device main body 11 (Step 2505) is stored in the RAM 26. In the case of a “Yes” determination in Step 2505, a fan-like surface including the intersection obtained in Step 2504, the other intersection stored in the RAM 26, and two other points positioned a predetermined radius from the center position is specified as a sub region (Step 2506), and coordinate information including the abovementioned intersections and the abovementioned two points is stored in the sub region/pitch table (Step 2507). It should be noted that it is desirable for the abovementioned two points to use points on a line connecting the intersection obtained in Step 2504 and the other intersection stored in the RAM 26, with the center position, respectively, and which makes a predetermined radius from the center position. Then, the CPU 21 sets the sub region setting flag stored in the RAM 26 to “1” (Step 2508).

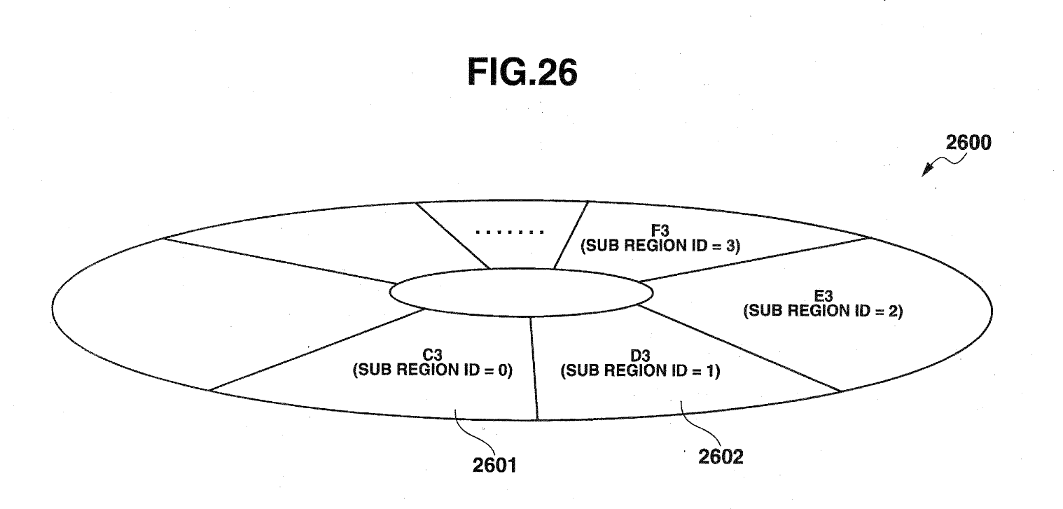

FIG. 26 is a diagram showing an example of a main region and sub regions according to the other embodiments. As shown in FIG. 26, predetermined fan-like sub regions (for example, refer to the reference numerals 2601, 2602) are set in the main region 2600 and a pitch is assigned to each of the sub regions. Furthermore, in a case of a tone of percussion being assigned to the main region, a second tone (a specific tone such as a snare, hi-hat, toms, and the like), which becomes a sub category of a tone of percussion may be set to a sub region.

According to the other embodiment, based on the center position and another position on the ground level that are formed by projecting a designated center position and the other position different from the center position onto the ground level, the CPU 21 determines, as a main region, a circular column with the center position on the ground level as the center and with a circle passing through the other position on the ground level as a bottom surface. In this way, it is possible to set a main region based on a desired circular two-dimensional surface based on the center position and a predetermined position (a passing position).

Furthermore, according to the alternative embodiment, in the main region that is determined based on the center position and the other position on the ground level that are formed by projecting a designated center position and another position different from the center position onto the ground level, the CPU 21 specifies, as a sub region, a fan-like region including two intersections of an outer profile of the main region and a line passing through a position of the playing device main body 11 as a held member, and the center position and other two positions positioned a predetermined radius from the center position. In this way, it is possible to set a fan-like sub region in the main region.

Furthermore, in the first to fourth embodiments, the CPU 21 of the playing device main body 11 detects a geomagnetic sensor value and an acceleration sensor value while the performer is swinging the playing device main body 11, obtains positional information of the playing device main body 11 based on these sensor values, and determines whether the playing device main body 11 is positioned within the main region. When the CPU 21 determines that the playing device main body 11 is swung while it is positioned within the main region, and is positioned on the sub region or passes through the sub region, the CPU 21 generates a Note-On-Event including a tone associated with the main region and a pitch associated with the sub region, and transmits it to the instrument unit 19 via the I/F 27 and the infrared communication apparatus 24. On the other hand, upon receiving the Note-On-Event at the instrument unit 19, the CPU 12 outputs the Note-On-Event thus received to the sound source unit 31 to generate a musical sound. It is preferable to employ the abovementioned configuration in a case of the instrument unit 19 not being a device dedicated to generating a musical sound, such as a personal computer or a game machine in which a MIDI board is installed.

However, the assignments of the processes to the playing device main body 11 and the instrument unit 19 are not limited to the abovementioned embodiments. For example, it may be configured such that the playing device main body 11 transmits information of the main region/tone table and the sub region/pitch table to the instrument unit 19, and obtains positional information in the playing device main body based on sensor values and transmit them to the instrument unit 19. In this case, the sound generation timing detecting process (FIG. 13) and the Note-On-Event generation process (FIG. 14) are executed in the instrument unit 19. The abovementioned configuration is suited for an instrument unit that is an electronic musical instrument dedicated to generating musical sound.

Furthermore, although data is communicated by infrared signals using the infrared communication apparatuses 24 and 33 between the playing device main body 11 and the instrument unit 19 in the present embodiment, the present invention is not limited thereto. For example, data communication between the playing device main body 11 and the instrument unit 19 may be performed through another wireless communication means or may be performed through a wire cable.

Furthermore, although the movement direction of the playing device main body 11 is detected by the geomagnetic sensor 23 and the displacement of the playing device main body 11 is detected by the acceleration sensor 22, and thus the position of the playing device main body 11 is obtained based on this information, the present invention is not limited to such a method, and it may be configured such that the position of the playing device main body 11 is obtained using the sensor value from a triaxial acceleration sensor or the sensor value of an angular velocity sensor.

On the other hand, although a sound generation timing of musical sound is set as when the playing device main body 11 is positioned within the main region as well as positioned within the sub region in the abovementioned embodiment, it can be configured differently therefrom.

For example, it can be configured such that the acceleration sensor 22 determines whether the playing device main body 11 is swung and determines the time when it is swung as the time when a musical sound is generated.

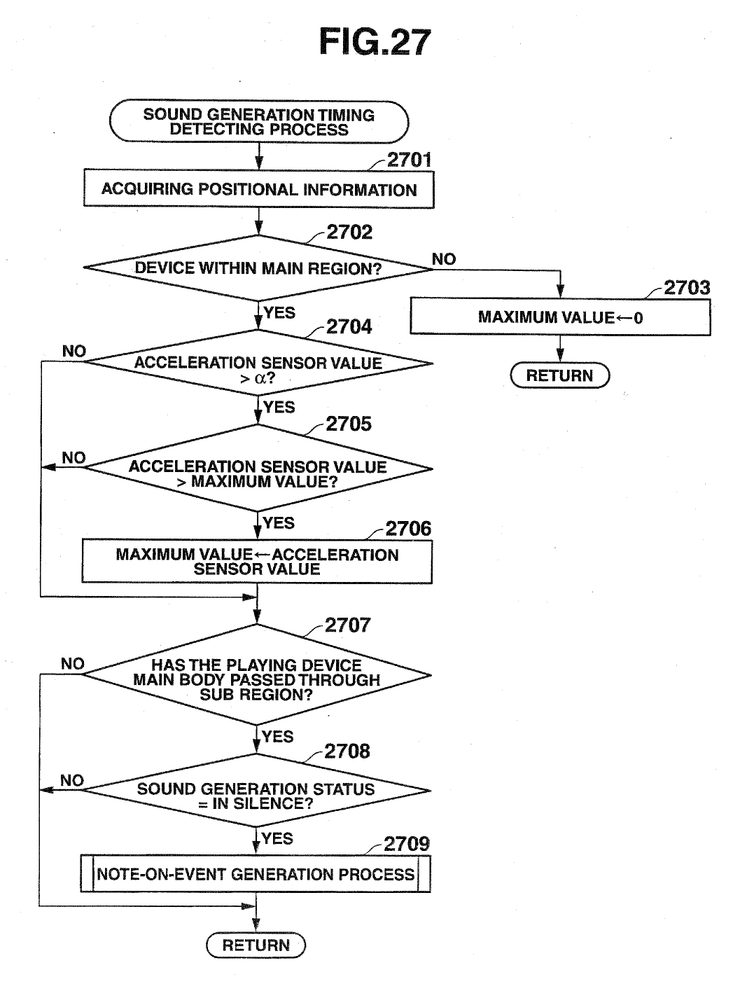

FIG. 27 is a flowchart of a sound generation timing detecting process that is applied to other configurations. The processes from Step 2701 to 2709 in FIG. 27 are the same as the processes from Step 1301 to 1309 of the sound generation timing detecting process in FIG. 13. The only differing aspect of processes of FIG. 27 from the processes of FIG. 13 is that, in the case of a “No” determination in Step 1304 and 1305 in FIG. 13, the process flow advances to Step 1307; whereas, in the case of a “No” determination in Step 2704 and 2705 in FIG. 27, the process flow of this flowchart ends.

Therefore, in FIG. 27, the process flow can advance to a Note-On-Event process of Step 2709 via Steps 2707 and 2708, and thus it becomes possible to generate a musical sound when the playing device main body 11 is swung on the condition that the acceleration detected by the acceleration sensor 22 is no less than a (a “Yes” determination in Step 2704) and the acceleration thus detected exceeds a predetermined maximum value (a “Yes” determination in Step 2705).

By applying such a configuration, it becomes possible to generate a musical sound only when a swinging operation that is close to the actual operation of percussion to make a sound is made; therefore, it is possible to give a more realistic feeling to a musical performance.

Furthermore, in the abovementioned embodiment, it is configured such that, the pitch of a musical sound to be generated will not vary, even if the playing device main body 11 falls in any position within a single sub region. However, a configuration can be assumed in which the pitch of a musical sound to be generated can be altered depending on the position of the playing device main body 11 within a single sub region.

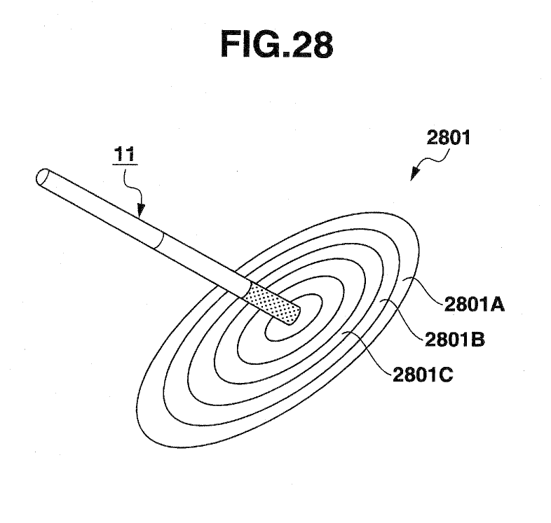

For example, as shown in FIG. 28, a sub region 2801 is set as a region surrounded by a circle with a position designated by the playing device main body 11 as the center. A predetermined pitch is associated with this sub region 2801. Furthermore, this sub region 2801 is divided into concentric small areas 2801A, 2802B, 2801C . . . and the abovementioned pitch is assigned to each of the areas, but the value of the pitch is changed gradually step-wise for each of the areas. For example, a higher pitch is assigned to an area closer to the center.

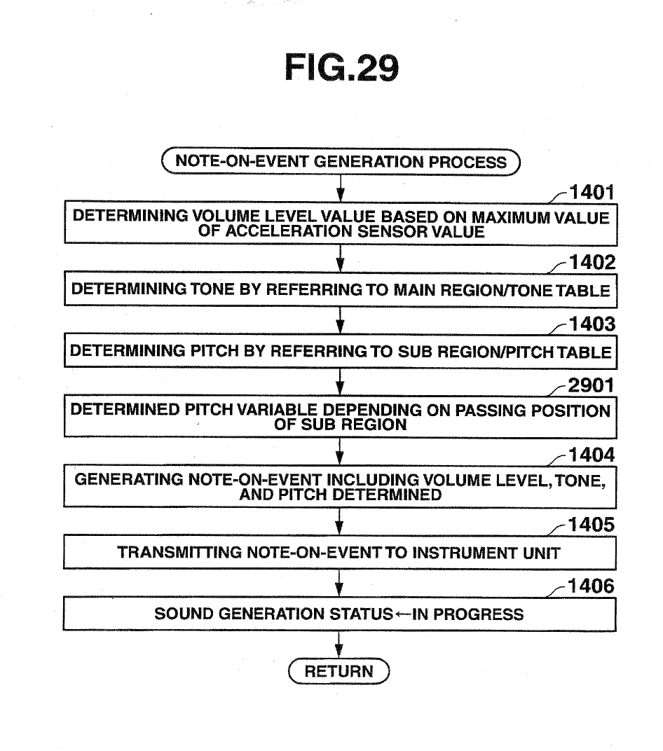

FIG. 29 is a flowchart of a Note-On-Event according to the present configuration. In FIG. 29, parts identical with those in FIG. 14 are denoted with the same number and explanations thereof are omitted.

After a pitch is determined with reference to the sub region/pitch table in Step 1403 of FIG. 29, the process flow advances to Step 2901. In Step 2901, the value of the pitch thus determined is varied based on whether or not the playing device main body 11 has passed through a position within any of the sub regions. Then, the CPU 21 sets the pitch of which value has been changed as the pitch that has been determined, and the process flow advances to Step 1404.

By establishing such a configuration, it is possible to slightly change the pitch of a musical sound to be generated in accordance with the position struck as with an actual musical performance of percussion.

Although the pitch of a musical sound to be generated can be altered depending on a position of the playing device main body 11 within a single sub region in the abovementioned configuration, it can be configured such that other parameters of a musical sound such as tone are altered.

Although the embodiments of the present invention are described in detail above, the scope of the present invention is not to be limited to the abovementioned embodiments, and the invention described in the claims and the scope of equivalents thereto are included in the scope of the present invention.

What is claimed is:

1. A musical performance apparatus comprising:
a held member that a performer can hold by hand;
a tone storing unit that stores information which specifies a main region having at least a lateral surface in a space demarcated by a surface that is perpendicular to ground level, and a tone of a musical sound that is associated with the main region;
a pitch storing unit that stores information which specifies a sub region that is positioned in the main region, and a pitch of a musical sound that is associated with the sub region;
a positional information acquisition unit that acquires information of a position of the held member;
a reading unit that reads, from the tone storing unit, a tone associated with the main region in which a position of the held member resides when the position of the held member acquired by the positional information acquisition unit is within the main region and resides within the sub region, and that reads, from the pitch storing unit, a pitch associated with the sub region to which the position of the held member resides; and
a sound generation instructing unit that instructs a sound generating unit to generate a musical sound having the tone and pitch read by the reading unit.

2. The musical performance apparatus according to claim 1, further comprising:
a tone setting unit that, based on positional information of at least three apexes designated, sets a surface obtained by projecting a surface connecting the apexes onto a ground level as a bottom surface, determines a space demarcated by the bottom surface and perpendicular lines extending from the apexes as the main region, and stores the information which specifies the main region in the tone storing unit to be associated with the tone.

3. The musical performance apparatus according to claim 1, further comprising:
a tone setting unit that, based on a center position on the ground level and one other position on the ground level that are respectively formed by projecting a center position and one other position different from the center position that are designated onto the ground level, determines, as a main region, a circular column with the center position on the ground level as a center and with a circle passing through the one other position on the ground level as a bottom surface, and stores information which specifies the main region in the tone storing unit to be associated with the tone.

4. The musical performance apparatus according to claim 1, further comprising:
a tone setting unit that specifies a trajectory of the held member by acquiring positional information in a predetermined time interval, determines, as the main region, a column-shaped region with a bottom surface thereof being shaped by a closed curve on the ground level onto which the trajectory of the held member is projected, and stores the information which specifies the main region in the tone storing unit to be associated with the tone.

5. The musical performance apparatus according to claim 1, further comprising:
a pitch setting unit that, based on positional information of at least three apexes designated, determines a surface connecting the apexes as the sub region, and stores the information which specifies the sub region in the pitch storing unit to be associated with the pitch.

6. The musical performance apparatus according to claim 1, further comprising:
a pitch setting unit that, based on positional information of a center position and positional information of one other position different from the center position that are designated, sets the center position as a center, determines a circular surface passing through the one other position as the sub region, and stores the information which specifies the sub region in the pitch storing unit to be associated with the pitch.

7. The musical performance apparatus according to claim 1, further comprising:
a pitch setting unit that specifies a trajectory of the held member by acquiring positional information in a predetermined time interval, determines the trajectory of the held member as the sub region, and stores the information which specifies the sub region in the pitch storing unit to be associated with the pitch.

8. The musical performance apparatus according to claim 5, wherein
the pitch setting unit divides a single region that has been set into a predetermined number of pieces, determines partial regions thus divided as the sub regions, respectively, assigns a predetermined pitch to each of the sub regions, and stores the information specifying each of the sub regions in the pitch storing unit to be associated with the pitch thus assigned, respectively.

9. The musical performance apparatus according to claim 1, further comprising:
a pitch setting unit that, in the main region determined based on a center position on the ground level and one other position on the ground level that are respectively formed by projecting a center position and one other position different from the center position that are designated onto the ground level, determines, as the sub region, a fan-like region including two intersections of an outer profile of the main region and a line passing through a position of the held member and the center position and other two points positioned a predetermined radius from the center position, and stores the information which specifies the sub region in the pitch storing unit to be associated with the pitch.

10. The musical performance apparatus according to claim 1, wherein
the sound generation instructing unit instructs the sound generating unit to generate a musical sound, with a sound generation timing as when the position of the held member acquired by the positional information acquisition unit is within the main region and resides to the sub region.

11. The musical performance apparatus according to claim 1, further comprising:
a determining unit that determines whether a swinging operation is applied to the held member, wherein
the sound generation instructing unit instructs the sound generating unit to generate a musical sound with a sound generation timing as when the determining unit determines that the swinging operation is applied to the held member.

12. The musical performance apparatus according to claim 1, wherein
the sound generation instructing unit further includes a pitch variable unit that can vary a pitch read from the pitch storing unit depending on the sub region in which the held member resides, and instructs the sound generating unit to generate a musical sound having a tone read by the reading unit and a pitch that has been varied by the pitch variable unit.

13. A musical performance apparatus comprising:
a held member that a performer can hold by hand;
a category storing unit that stores information which specifies a main region of which at least a lateral surface is demarcated by a surface that is perpendicular to ground level in a space, and a category of a tone of a musical sound that is associated with the main region;
a tone storing unit that stores information which specifies a sub region that is positioned in the main region, and a tone that is associated with the sub region and corresponds to a sub category into which the category is divided;
a positional information acquisition unit that acquires positional information of the held member;
a reading unit that reads, from the tone storing unit, a tone associated with the sub region in which the position of the held member acquired by the positional information acquisition unit resides, when the position of the held member is within the main region and resides in the sub region; and
a sound generation instructing unit that instructs a sound generating unit to generate a musical sound having the tone read by the reading unit.

14. The musical performance apparatus according to claim 1, wherein
the positional information acquisition unit includes a geomagnetic sensor and an acceleration sensor, and
wherein the musical performance apparatus detects a movement direction of the held member based on a sensor value of the geomagnetic sensor and calculates a displacement of the held member based on a sensor value of the acceleration sensor.

15. An electronic instrument unit comprising:
the musical performance apparatus according to claim 1; and
an instrument unit including a sound generating unit, wherein
the musical performance apparatus and the instrument unit include a communication unit, respectively.
